(19) United States
(12) Patent Application Publication
(10) Pub. No.: US 2025/0217403 A1
(43) Pub. Date: Jul. 3, 2025

(54) MACHINE LEARNING TECHNIQUES FOR QUESTION RESOLUTION

(71) Applicant: Optum, Inc., Minnetonka, MN (US)

(72) Inventors: Ardavan Saeedi, Jersey City, NJ (US); Jagadish Venkataraman, Menlo Park, CA (US); Joel David Stremmel, Iowa City, IA (US); Hamid Reza Hassanzadeh, Suwanee, GA (US)

(21) Appl. No.: 18/613,923

(22) Filed: Mar. 22, 2024

Related U.S. Application Data
(60) Provisional application No. 63/617,242, filed on Jan. 3, 2024.

(51) Int. Cl. G06F 16/383; G06F 16/33

(52) U.S. Cl. CPC G06F 16/383; G06F 16/3344

(57) ABSTRACT

Various embodiments of the present disclosure provide machine-learning question resolution techniques for improving question response outputs. The techniques may include receiving a plurality of evidence passages from a document set corresponding to an input question. The techniques may include generating, using a retrieval ensemble model, a plurality of evidence predictions for an evidence passage of the plurality of evidence passages based on the input question. The techniques may include generating, using the retrieval ensemble model, a weighted aggregate prediction for the evidence passage based on the plurality of evidence predictions. The techniques may include selecting, a set of input passages from the plurality of evidence passages based on the weighted aggregate prediction. The techniques may include generating, using a machine learning aggregation model, a question response based on the set of input passages and the input question. The techniques may include providing the question response.

### CROSS-REFERENCE TO RELATED APPLICATIONS

This application claims the benefit of U.S. Provisional Application No. 63/617,242, entitled “A DYNAMIC MODULAR MACHINE LEARNING APPROACH TO CLINICAL GUIDELINE ADHERENCE,” and filed Jan. 3, 2024, the entire contents of which are herein incorporated by reference.

### BACKGROUND

Various embodiments of the present disclosure address technical challenges related to machine learning query processing techniques. Traditional query processing techniques leverage monolithic machine learning models that are subject to a number of technical challenges, which limit the reliability of the output by such models as well as the range of available inputs for such models. For example, monolithic machine learning models may be tailored for specific processing tasks, but struggle to perform a complex, hierarchical arrangement of tasks that may be required to complete complex queries. As an example, a query may depend on complex sequences of sub-queries that may be arranged as a logical function, decision tree, and/or the like. Processing such queries requires multi-task process including (1) finding parts of a document that are relevant to each sub-question, and (2) determining whether the document satisfies the sub-question. Often, the complexity and diversity of the sub-questions and the long length of input documents impose numerous technical challenges, especially for monolithic machine learning architectures. For instance, a first sub-question may include questions that require temporal reasoning, another sub-question may require negation reasoning, whereas yet another may require an analysis of structure textual data within a document.

Various embodiments of the present disclosure make important contributions to traditional query processing and machine learning techniques by addressing these technical challenges, among others.

### BRIEF SUMMARY

Various embodiments of the present disclosure provide machine-learning architectures, configurations, and training techniques for improving traditional computer-based query processing techniques. To do so, some embodiments of the present disclosure provide a modular machine learning pipeline that is trained partially independently and partially end-to-end to break complex queries into independent sub-problems that may be answered and aggregated to process the complex query. By doing so, the modular machine learning pipeline may be generalizable to various types of complex queries that have traditionally confused machine learning query processing techniques.

More specifically, the modular machine learning pipeline may include a retrieval ensemble model that includes a plurality of machine learning models configured to individually extract evidence passages for a particular sub-question. The plurality of machine learning models may each be tailored to a particular retrieval task, such that the extracted evidence passages may be relevant to a plurality of different types of questions. The modular machine learning pipeline may include a fusion model that is trained to weigh the extracted evidence passages to further extract a set of input passages for answering the sub-question. The set of input passages may be provided to an aggregation model of the modular machine learning pipeline to generate the query response for the sub-question. In some embodiments, the plurality of retrieval models may be individually trained to specialize for a specific query processing task while the fusion and aggregation models may be jointly trained to be generalizable to any of a plurality of different query processing tasks. In this manner, may some embodiments of the present disclosure provide connected modules that leverage various machine learning techniques, including retrieval ensemble models, machine learning aggregation models, and/or the like, in a unique configuration to outperform single-model baselines. Further to ensure accuracy of the question resolution techniques, some embodiments of the present disclosure provide an evaluation process that leverages one or more metrics to assess output of the question resolution process and provides a synthetic data generation process that leverages generative pre-trained transformer models to continuously augment and refine training data sets for the various models of the machine learning pipeline. By doing so, the techniques of the present disclosure provide a modular machine learning configuration that is generalizable to any type of sub-question and is continuously trained to accommodate different sub-question types as they arise in a complex query domain.

In some embodiments, a computer-implemented method comprising receiving, by one or more processors, a plurality of evidence passages from a document set corresponding to an input question; generating, by the one or more processors and using a retrieval ensemble model, a plurality of evidence predictions for an evidence passage of the plurality of evidence passages based on the input question; generating, by the one or more processors and using the retrieval ensemble model, a weighted aggregate prediction for the evidence passage based on the plurality of evidence predictions; selecting, by the one or more processors, a set of input passages from the plurality of evidence passages based on the weighted aggregate prediction; generating, by the one or more processors using a machine learning aggregation model, a question response based on the set of input passages and the input question; and providing, by the one or more processors, the question response.

In some embodiments, a computing system comprising memory and one or more processors communicatively coupled to the memory, the one or more processors configured to receive a plurality of evidence passages from a document set corresponding to an input question; generate, using a retrieval ensemble model, a plurality of evidence predictions for an evidence passage of the plurality of evidence passages based on the input question; generate, using the retrieval ensemble model, a weighted aggregate prediction for the evidence passage based on the plurality of evidence predictions; select a set of input passages from the plurality of evidence passages based on the weighted aggregate prediction; generate, using a machine learning aggregation model, a question response based on the set of input passages and the input question; and provide the question response.

In some embodiments, one or more non-transitory computer-readable storage media including instructions that, when executed by one or more processors, cause the one or more processors to receive a plurality of evidence passages from a document set corresponding to an input question; generate, using a retrieval ensemble model, a plurality of evidence predictions for an evidence passage of the plurality of evidence passages based on the input question; generate, using the retrieval ensemble model, a weighted aggregate prediction for the evidence passage based on the plurality of evidence predictions; select a set of input passages from the plurality of evidence passages based on the weighted aggregate prediction; generate, using a machine learning aggregation model, a question response based on the set of input passages and the input question; and provide the question response.

### BRIEF DESCRIPTION OF THE DRAWINGS

FIG. 1 provides an example overview of an architecture in accordance with some embodiments of the present disclosure.

FIG. 2 provides an example predictive data analysis computing entity in accordance with some embodiments of the present disclosure.

FIG. 3 provides an example client computing entity in accordance with some embodiments of the present disclosure.

FIG. 4 is a dataflow diagram showing example data structures and modules for generating a question response in accordance with some embodiments discussed herein.

FIG. 5 is a flowchart diagram of an example process for generating annotated training set for a machine learning pipeline in accordance with some embodiments discussed herein.

FIG. 6 is a flowchart diagram of an example process for training models of a machine learning pipeline in accordance with some embodiments discussed herein.

FIG. 7 is a flowchart diagram of an example process for generating a question response in accordance with some embodiments discussed herein.

FIG. 8 is a flowchart diagram of an example process for evaluating a question resolution process in accordance with some embodiments discussed herein.

FIG. 9 is an end-to-end block diagram showing example data structures and modules for the question response generation process in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

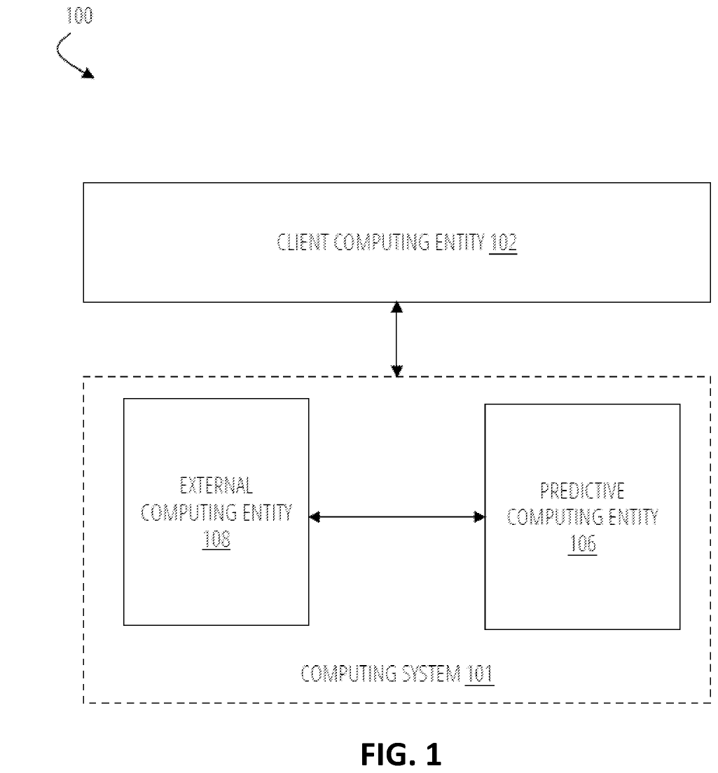

FIG. 1 provides an example overview of an architecture 100 in accordance with some embodiments of the present disclosure. The architecture 100 includes a computing system 101 configured to receive requests, such as a question resolution request, from client computing entities 102, process the requests to generate question response outputs, and provide the generated question response outputs to the client computing entities 102. The example architecture 100 may be used in a plurality of domains and not limited to any specific application as disclosed herewith. The plurality of domains may include banking, healthcare, industrial, manufacturing, education, retail, to name a few.

In accordance with various embodiments of the present disclosure, one or more machine learning models may be trained to generate one or more annotated training sets, classifications, and/or question responses. The models may form a machine learning pipeline that may be configured to determine relevant evidence passages from a document set corresponding to an input question, and leverage the relevant evidence passages to generate a question response for the input question. This technique will lead to more accurate, reliable, and generalizable query processing techniques that may be efficiently used for a diverse set of different cases.

In some embodiments, the computing system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may include a predictive computing entity 106 and one or more external computing entities 108. The predictive computing entity 106 and/or one or more external computing entities 108 may be individually and/or collectively configured to receive question resolution requests from client computing entities 102, process the requests to generate outputs, such as question responses comprising question resolution and evidence passages, and provide the generated outputs to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data analysis and/or training tasks. The storage subsystem may include one or more storage units, such as multiple distributed storage units that are connected through a computer network. Each storage unit in the respective computing entities may store at least one of one or more data assets and/or one or more data about the computed properties of one or more data assets. Moreover, each storage unit in the storage systems may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In some embodiments, the predictive computing entity 106 and/or one or more external computing entities 108 are communicatively coupled using one or more wired and/or wireless communication techniques. The respective computing entities may be specially configured to perform one or more steps/operations of one or more techniques described herein. By way of example, the predictive computing entity 106 may be configured to train, implement, use, update, and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., question resolution techniques, classification techniques, evaluation techniques, synthetic data generation techniques, and/or the like) described herein. The external computing entities 108, for example, may include and/or be associated with one or more entities that may be configured to receive, transmit, store, manage, and/or facilitate datasets, such as annotated training sets, and/or the like. The external computing entities 108, for example, may include data sources that may provide such datasets, and/or the like to the predictive computing entity 106 which may leverage the datasets to perform one or more steps/operations of the present disclosure, as described herein. In some examples, the datasets may include an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for a prediction domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data, etc.) from the use of the machine learning model may be recorded by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Predictive Computing Entity

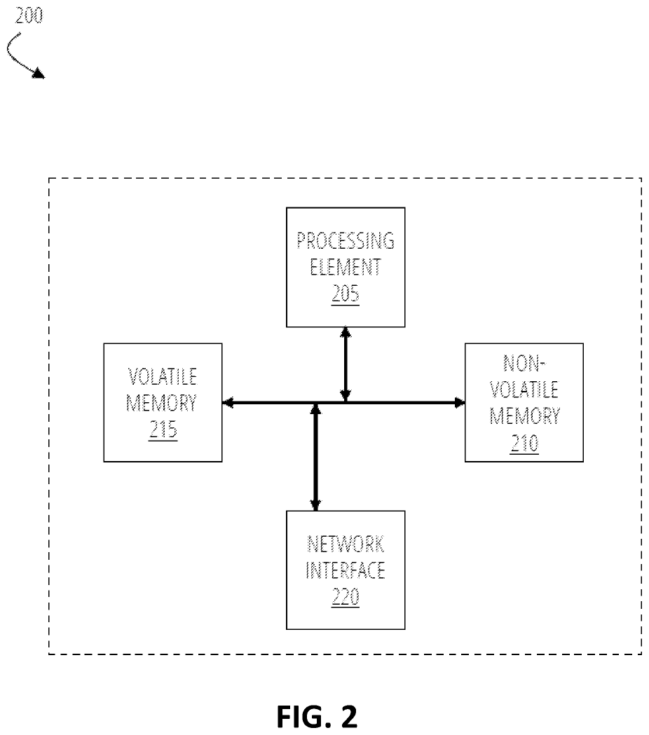

FIG. 2 provides an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106, etc.) may train and use one or more machine learning models described herein. In other embodiments, a first computing entity (e.g., predictive computing entity 106, etc.) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets, etc.) to the first computing entity over a network.

As shown in FIG. 2, in some embodiments, the computing entity 200 may include, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further include, or be in communication with, non-volatile media (also referred to as non-volatile storage, memory, memory storage, memory circuitry, and/or similar terms used herein interchangeably). In some embodiments, the non-volatile media may include one or more non-volatile memory 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile media may store databases, database instances, database management systems, data, applications, programs, program modules, scripts, code (e.g., source code, object code, byte code, compiled code, interpreted code, machine code, etc.) that embodies one or more machine learning models or other computer functions described herein, executable instructions, and/or the like. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In some embodiments, the computing entity 200 may further include, or be in communication with, volatile media (also referred to as volatile storage, memory, memory storage, memory circuitry, and/or similar terms used herein interchangeably). In some embodiments, the volatile media may also include one or more volatile memory 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, code (source code, object code, byte code, compiled code, interpreted code, machine code) that embodies one or more machine learning models or other computer functions described herein, executable instructions, and/or the like being executed by, for example, the processing element 205. Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 with the assistance of the processing element 205 and operating system.

As indicated, in some embodiments, the computing entity 200 may also include one or more network interfaces 220 for communicating with various computing entities (e.g., the client computing entity 102, external computing entities, etc.), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may include, or be in communication with, one or more input elements, such as a keyboard input, a mouse input, a touch screen/display input, motion input, movement input, audio input, pointing device input, joystick input, keypad input, and/or the like. The computing entity 200 may also include, or be in communication with, one or more output elements (not shown), such as audio output, video output, screen/display output, motion output, movement output, and/or the like.

### B. Example Client Computing Entity

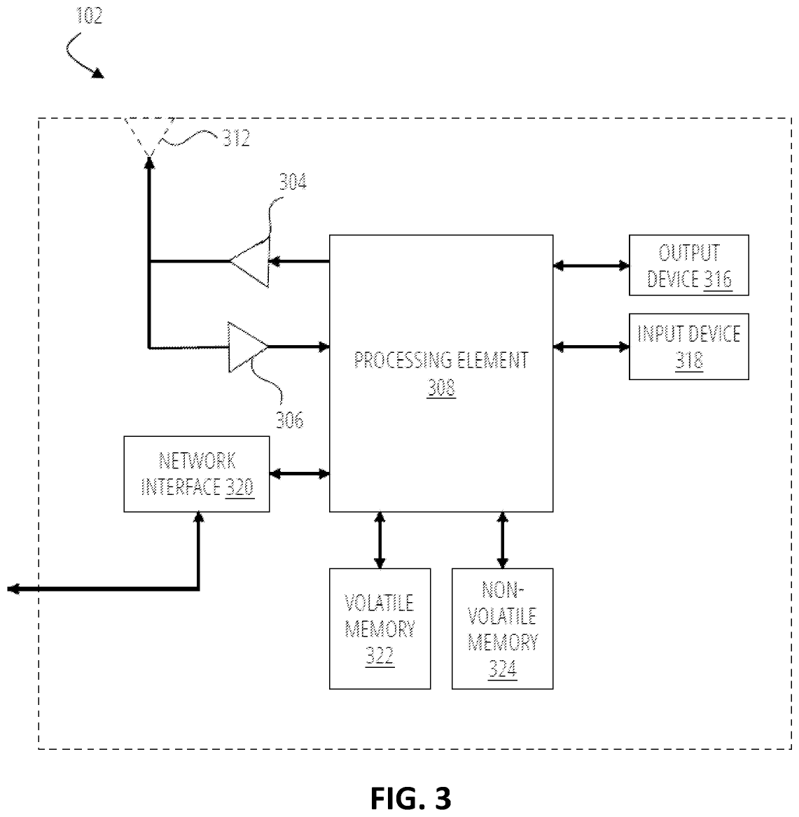

FIG. 3 provides an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the computing entity 200. In some embodiments, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the computing entity 200 via a network interface 320.

Via these communication standards and protocols, the client computing entity 102 may communicate with various other entities using mechanisms such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 may also download code, changes, add-ons, and updates, for instance, to its firmware, software (e.g., including executable instructions, applications, program modules), and operating system.

According to some embodiments, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In some embodiments, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the DecimalDegrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface (that may include an output device 316 (e.g., display, speaker, tactile instrument, etc.) coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the computing entity 200, as described herein. The user input interface may comprise any of a plurality of input devices 318 (or interfaces) allowing the client computing entity 102 to receive code and/or data, such as a keypad (hard or soft), a touch display, voice/speech or motion interfaces, or other input device. In some embodiments including a keypad, the keypad may include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The client computing entity 102 may also include volatile memory 322 and/or non-volatile memory 324, which may be embedded and/or may be removable. For example, the non-volatile memory 324 may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory 322 may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile memory may store databases, database instances, database management systems, data, applications, programs, program modules, scripts, code (source code, object code, byte code, compiled code, interpreted code, machine code, etc.) that embodies one or more machine learning models or other computer functions described herein, executable instructions, and/or the like to implement the functions of the client computing entity 102. As indicated, this may include a user application that is resident on the client computing entity 102 or accessible through a browser or other user interface for communicating with the computing entity 200 and/or various other computing entities.

In another embodiment, the client computing entity 102 may include one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### III. Examples of Certain Terms

In some embodiments, the term “document set” refers to a collection of data items that describe one or more units of text (e.g., one or more words, sentences, phrases, etc.). For example, each data item of a collection of data items may include one or more portions of text in a structured format, unstructured format, semi-structured format, and/or combinations thereof. In some examples, a data item may describe a natural language document, such as a Portable Document Format (PDF) file and/or any other document type (e.g., Hyper-Text Markup Language (HTML) file, etc.). For instance, a data item may include a scanned physical document, an electronic record, and/or the like. The type of document or record may be based on the prediction domain. As examples, for a clinical domain, a data item may include a medical document, such as a medical chart, clinical notes, discharge summaries, and/or the like. In such a case, a document set may include a plurality of medical documents that form a clinical history for a particular user.

In some embodiments, a document set includes a plurality of electronic representations of one or more documents. By way of example, the plurality of electronic representations may include a plurality of computer readable text that may be imaged and converted to computer readable text via one or more optical character recognition (OCR) techniques. In this manner, a dataset creation module may be configured to covert an image, such as scanned PDF document, into a format that is consumable by one or more models of the present disclosure.

In some embodiments, a document set is decomposed into one or more individual text segments that may be analyzed individually and/or in one or more combinations using some of the techniques of the present disclosure. An individual text segment, for example, may include an evidence passage for generating a predictive output.

In some embodiments, the term “evidence passage” refers to an individual text segment from a document set. For example, an evidence passage may include a portion of a natural language document that includes a segment of text, such as one or more phrases, one or more sentences, one or more paragraphs, and/or the like from the document set. In some examples, a plurality of evidence passages may be extracted from a document set. Each evidence passage may be individually processed (e.g., by one or more models of the present disclosure) to generate a predictive output for an input question.

In some embodiments, the term “input question” refers to a data entity that describes a request for information associated with a document set. An input question, for example, may include a structured and/or unstructured complex query associated with a predefined criteria set. For instance, a predefined criteria set may include one or more comprehensive requirements for an overall predictive output. The predefined criteria set, for example, may include a sequence of logical functions that define one or more partially dependent requirements of the overall predictive output. The predefined criteria set may be decomposed into a plurality of input questions. Each input question may include structured and/or unstructured text that defines a question (e.g., a binary question, a categorical question, etc.) that may be answered using information from a document set. An overall prediction output may be generated by processing a series of input questions to satisfy at least a subset of the predefined criteria set for the overall predictive output. In some examples, a plurality of input questions may correspond to a single criterion of the predefined criteria set. For example, criterion that may include a plurality of predefined options (e.g., a multi-choice question, etc.) may be decomposed into individual input questions that respectively correspond to the plurality of predefined options.

In some embodiments, an input question originates from or is otherwise extracted from one or more criteria documents, such as guideline documents, knowledge library documents, standard operation procedures, and/or the like. By way of example, in a clinical domain, an overall predictive output may correspond to a medical necessity check that is structured as a series of checklists. Each checklist may be presented in either a simple, straightforward format or a more complex, hierarchical arrangement, such as decision trees. The overall predictive output (e.g., a final decision) for the medical necessity check may be a logical function of the checked items in the checklist or the selected branches in the decision tree. In such a case, an input question may include request for information to complete an item from the checklist, a node from a decision tree, and/or the like.

In a clinical domain and/or any other predictive domain with complex criteria sets, the complexity and diversity of the criteria sets, such as clinical guidelines, and the long length along with the longitudinal nature of corresponding document sets, such as medical charts, impose numerous challenges on this task. For instance, one guideline may contain questions that require temporal reasoning (e.g., has the patient received any analgesic in the last 3 months), and another one may need reasoning about negation (e.g., the patient has none of arthritis, joint subluxation, or subchondral cysts). These challenges make monolithic machine learning solutions to this problem less desirable. In contrast a modular approach that may treat different challenges independently is more generalizable to new guideline question types.

In some embodiments, an input question includes a query for information from a document set and logic for determining whether the document set (and/or a user associated therewith) satisfies a criterion based on the information. For example, a predictive output for an input question may include a question response that is based on information extracted from the document set and includes a determination of whether the document set (and/or a user associated therewith) satisfies a criterion.

In some embodiments, the term “question response” refers to a data entity that describes a predictive output for an input question. The question response may include one or more natural language terms and/or phrases that represents an answer to an input question. Additionally or alternatively, the question response may include one or more evidence passages that support an answer to an input question. For example, the question response may include a question resolution and an evidence passage from the document set that was leveraged to generate the question resolution. The question resolution, for example, may include a binary, categorical, natural language, and/or any other form of response to an input question. In some examples, the question resolution may be generated by a machine learning pipeline that may identify a plurality of evidence passages from a document set for the input question, select an evidence passage for answering the input question, and generate the question resolution based on the selected evidence passage. In some examples, the selected evidence passage may be provided as support for the question resolution.

In some embodiments, the term “machine learning pipeline” refers to a data entity that describes a sequence of computing tasks for generating a question response from an input question. In some examples, the machine learning pipeline may include a plurality of connected modules configured to perform one or more operation associated with a multi-stage machine-learning process. The multi-stage process, for example, may include a plurality of training and inference phases for training, implementing, and continuously retraining one or more machine learning models. The plurality of connected modules, for example, may include (i) an annotation module configured to provide manual labels for training documents given a training question, (ii) a dataset creation module configured to generate a document set, (iii) a fine-tuning module configured to train a retrieval ensemble model and/or machine learning aggregation model for performing one or more portions of a question resolution process, (iv) an inference module configured to implement the trained retrieval ensemble model and/or machine learning aggregation model to perform the one or more portions of the question resolution process, and/or an evaluation module configured to evaluate one or more predictive outputs of the question resolution process and, based on the evaluation, initiate one or more retraining operations.

In some embodiments, the term “retrieval ensemble model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). The retrieval ensemble model may include one or more of any type of machine learning model including one or more supervised, unsupervised, semi-supervised, reinforcement learning models, and/or the like. For example, the retrieval ensemble model may include multiple models configured to individually and/or collectively perform one or more stages of a question resolution process. For example, the multiple models may be trained at least partially end-to-end and/or individually to generate a weighted aggregate prediction for an evidence passage from a document set based on an input question. In some examples, the weighted aggregate prediction may be aggregated from a plurality of intermediate evidence predictions for the evidence passage.

For example, a retrieval ensemble model may include a plurality of classification models and a machine learning fusion model. The plurality of classification models may be configured (e.g., trained, etc.) to respectively generate a plurality of evidence predictions for an evidence passage based on an input question. The plurality of evidence predictions may be input to a connected machine learning fusion model to generate a weighted aggregate prediction for the evidence passage. In this manner, the retrieval ensemble model may be configured, trained, and/or the like to (i) generate a plurality of evidence predictions for an evidence passage with respect to an input question (e.g., using one or more classification models thereof, etc.) and (ii) generate a weighted aggregate prediction for an evidence passage based on plurality of evidence predictions (e.g., using a machine learning fusion model thereof, etc.).

In some embodiments, the term “temporal extraction model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). The temporal extraction model may include one or more of any type of machine learning model including one or more supervised, unsupervised, semi-supervised, reinforcement learning models, and/or the like. For example, the temporal extraction model may include multiple models configured to individually and/or collectively perform one or more stages of a temporal feature extraction process.

In some embodiments, a training set of temporal features is obtained from one or more annotators and/or a first large language models (LLM) during a training and/or modeling phase. For example, the first LLM may be configured (e.g., trained, etc.) to output temporal features associated with a training document set. By way of example, the first LLM may include a powerful and expensive LLM such as a LLAM-70B. In some embodiments, a second LLM may be finetuned based on the set of temporal features obtained from the annotators and/or the first LLM. The finetuned LLM may be configured to receive an evidence passage as input, during an inference phase, and output a set of temporal features associated with the evidence passage. By way of example, the finetuned LLM may include a more efficient and less expensive LLM relative to the first LLM. In a clinical domain, a non-limiting example of such finetuned LLM is a biomedical and clinical language model such as a BioRoberta model. In some embodiments, for a particular evidence passage that does not include temporal features, the finetuned model is configured to identify the last preceding evidence passage that includes temporal features and output the temporal features associated with this last preceding evidence passage as the set of temporal features for the particular evidence passage.

In some embodiments, the term “set of temporal features” refers to a data entity that describes a collection of one or more temporal data features associated with one or more evidence passages. The set of temporal features may be provided as a subset of input to one or more models to generate a question response (and/or one or more intermediate prediction thereof) for an input question.

In some embodiments, the term “temporal data feature” refers to a data entity that describes temporal information associated with an event. For example, a temporal feature may include a timestamp (e.g., date, time, and/or the like) associated with the occurrence of an event. In a clinical domain, the temporal data feature may include a date and/or time of a clinical visit, laboratory visit, and/or the like. By way of example, one or more models may be configured, trained, and/or the like to output temporal data feature associated with an evidence passage. For example, one or more LLMs may be configured, trained, and/or the like to receive an evidence passage as input and output a temporal data feature for the evidence passage.

In some embodiments, the term “classification model” refers to a data entity that describes parameters, hyper-parameters, and/or defined operations of a rules-based algorithm and/or machine learning model (e.g., model including at least one or more rule-based layers, one or more layers that depend on trained parameters, coefficients, and/or the like), and/or the like. A classification model may include any type of model configured, trained, and/or the like to generate an evidence prediction for an evidence passage. A classification model may include one or more of any type of machine learning model including one or more supervised, unsupervised, semi-supervised, reinforcement learning models, and/or the like. In some examples, a retrieval ensemble model includes one or more different classification models of different types. For instance, a first classification model may include a term-based retrieval model and one or more second classification models may include one or more different classification LLMs.

In some embodiments, a classification model is configured to generate an evidence prediction. For example, during a training and/or modeling phase, the evidence prediction may include a positive relevance classification and/or a negative relevance classification. By way of example, a classification model may be previously trained to classify an evidence passage into the predefined category and/or assign a relevance rank value to the evidence passage. In some examples, the classification model may be trained (e.g., via back-propagation of errors, etc.) individually and/or jointly with one or more other models using an annotated training dataset. For example, a classification model may be jointly trained with one or more machine learning fusion models using a plurality of annotated training document sets. The machine learning fusion model may be configured to dictate or otherwise determine the ensemble weights for each classification model (e.g., term-based retrieval model, classification LLM, etc.). A classification model may be configured to receive an input question and one or more evidence passages during an inference phase and rank the evidence passages based on their relevance to the input question. In some embodiments, the noted ranking task may take the form of a classification task during modeling and/or training phase where a training evidence passage that is related to a training input question is assigned a positive relevance label (e.g., “1”) and a training evidence passage that is not related to the input quest is assigned a negative relevance label (e.g., “0”). For example, during a modeling and/or training phase, a classification model may be finetuned using the annotated training dataset to assign a training evidence passage a positive label or a negative label based on the relevance of the training input question to the training evidence passages.

In some embodiments, the term “term-based retrieval model” refers to a type of classification model. A term-based retrieval model may be configured to process natural language text to generate an output. In some examples, a term-based retrieval model may include a rule-based and/or machine learning model. In some embodiments, the term-based retrieval model may be configured to generate an output based on keyword matching and may not require finetuning. In this regard, a term-based retrieval model may provide for retrieving evidence passages that may be semantically different from the input question but share keywords with the input question. As one example, a term-based retrieval model may include a ranking algorithm, such as a bag-of-words function, that ranks an evidence passage by matching natural language text of the evidence passage to an input question. By way of example, a term-based retrieval model may include a BM25 model, Term Frequency-Inverse Document Frequency (TF-IDF) model, and/or the like. The term-based retrieval model may be configured to rank evidence passages based on their relevance to the input question and output the top N ranked evidence passages, where N may be any number (e.g., 2 5, 7, 20, etc.). For example, during an inference phase, one or more evidence passages may be input to the term-based retrieval model to output the top N ranked relevant evidence passages of the one or more evidence passages.

In some embodiments, the term “classification LLM” refers to a type of classification model. The classification LLM, for example, may be configured to process natural language text, using one or more machine learning techniques, to generate an output. In some examples, a classification LLM may include an LLM, such as one or more generative pre-trained transformers, bidirectional encoder representations from transformers (BERT), T5, robustly optimized BERT, and/or the like. In some examples, a classification LLM may be at least partially finetuned using the annotated training set.

In some embodiments, the term “machine learning fusion model” refers to a data entity that describes parameters, hyper-parameters, and/or defined operations of a rules-based algorithm and/or machine learning model (e.g., model including at least one or more rule-based layers, one or more layers that depend on trained parameters, coefficients, and/or the like), and/or the like. The machine learning fusion model may be configured to process prediction output of one or more classification models to generate weight values for the prediction outputs. By way of example, the machine learning fusion model may be trained, configured, and/or the like to process evidence prediction outputs from one or more classification models to generate weight values for the evidence prediction outputs. In some examples, the machine learning fusion model may be trained (e.g., via back-propagation of errors, etc.) individually and/or jointly with the one or more classification models using the annotated training dataset. For example, the machine learning fusion model may be trained jointly with one or more classification models using a plurality of annotated training document sets. The machine learning fusion model may form a portion of a retrieval ensemble model. The machine learning fusion model may be configured to dictate or otherwise determine the ensemble weights for each classification model (e.g., term-based retrieval model, classification LLM). For example, the weighted average of the prediction of the classification models may be input to the machine learning fusion model to finetune the weights of the classification models based on the annotated training data set. In this regard, the ensemble retrieval model may outperform single-model baselines/architectures.

In some embodiments, the term “evidence prediction” refers to a data entity that describes a classification model output. For example, an evidence prediction may be an intermediate output of a retrieval ensemble model. An evidence prediction may describe a predicted likelihood of relevance of an evidence passage to an input question. For example, an evidence prediction may be indicative of a likelihood that an evidence passage includes data/information that may answer an input question and/or support an answer to an input question). An evidence prediction may be generated using classification LLMs, term-based retrieval models, and/or the like, which may form a subset of a retrieval ensemble model.

In some embodiments, the term “weighted aggregate prediction” refers to data entity that describes a measure of a weighted combination of prediction outputs from one or more classification models. For example, the weighted aggregate prediction may describe a measure of a weighted combination of evidence predictions for an evidence passage that are individually output by one or more classification models. In some examples, the weight values applied to the prediction outputs to generate the weighted aggregate prediction may be learned by the machine learning fusion model.

In some embodiments, the term “annotated training set” refers to training data for a prediction domain. For example, an annotated training set may include a plurality of historical labeled document sets. Each historical labeled document set may include a historical document set, a manual and/or synthetic label, and a training input question. The manual and/or synthetic label may correspond to a training question response for training input question. For instance, the manual and/or synthetic label may include a training question resolution and/or a training evidence passage corresponding to the training question resolution. In some examples, the annotated training set may be leveraged to finetune one or more machine learning models described herein, including the classification models, the fusion models, the retrieval ensemble model, and/or the like. In some examples, the annotated training set may include one or more portions. A first portion may include a training portion used to finetune the one or more models. A second portion may include an annotated validation training set that may be leveraged to evaluate a performance of an at least partially trained model (e.g., classification model, fusion model, retrieval ensemble model, etc.).

In some embodiments, the term “positive relevance classification” refers to a data entity that describes a type of evidence prediction output. For example, a positive relevance classification may reflect a similarity between an evidence passage and an input question. In some examples, the positive relevance classification may include a real-number, percentage, ratio, and/or the like that describes a relative similarity of an evidence passage. In addition, or alternatively, a positive relevance classification may include a binary classification that indicates whether the evidence passage is relevant (e.g., a “1,” “true,” etc.) and/or irrelevant (e.g., “0,” “false,” etc.) to an input question. In some examples, the positive relevance classification may be based on a comparison between an evidence prediction output (e.g., a percentage, ratio, etc.) and a relevancy threshold (e.g., higher than 75%, etc.).

In some embodiments, the term “negative relevance classification” refers to a data entity that describes a type of evidence prediction output. For example, a negative relevance classification may reflect a dissimilarity between an evidence passage and an input question. In some examples, the negative relevance classification may include a real-number, percentage, ratio, and/or the like that describes a relative dissimilarity of an evidence passage. In addition, or alternatively, a negative relevance classification may include a binary classification that indicates whether the evidence passage is irrelevant (e.g., a “1,” “true,” etc.) and/or relevant (e.g., “0,” “false,” etc.) to an input question. In some examples, the negative relevance classification may be based on a comparison between an evidence prediction output (e.g., a percentage, ratio, etc.) and a relevancy threshold (e.g., lower than 75%, etc.).

In some embodiments, the term “set of input passages” refers to a data entity that describes a model input. The set of input passages may include one or more evidence passages from a document set that are determined, via execution of a machine learning pipeline, to be relevant (e.g., most relevant) for generating a question response for an input question. For example, the set of input passages may be selected from one or more evidence passages based on a weighted aggregate prediction associated with each of the one or more evidence passages.

In some embodiments, the term “machine learning aggregation model” refers to a data entity that describes parameters, hyper-parameters, and/or defined operations of a rules-based algorithm and/or machine learning model (e.g., model including at least one or more rule-based layers, one or more layers that depend on trained parameters, coefficients, and/or the like), and/or the like. The machine learning aggregation model may be configured to process a set of input passages in order to generate a question response for an input question. By way of example, the machine learning aggregation model may be configured, trained, and/or the like to process a set of one or more input passages output from a retrieval ensemble model to generate a question response for an input question. The machine learning aggregation model may include one or more of any type of machine learning model including one or more supervised, unsupervised, semi-supervised, reinforcement learning models, and/or the like. In some examples, the machine learning aggregation model may include multiple models configured to perform one or more different stages of a prediction process. In some examples, the machine learning aggregation model may include a branched, multi-model architecture. By way of example, the machine learning aggregation model may include one or more sub-classification models, one or more generative-pre-trained transformer model, one or more routing modules, and/or the like. In some embodiments, the one or more sub-classification models include one or more encoder-based LLMs and/or one or more decoder-based LLMs. In some embodiments, the routing module may be configured to route an input question and set of input passages to an encoder-based LLM or decoder-based LLM based on the answer type associated with the input question.

In some embodiments, the encoder-based LLM is a finetuned encoder-based LLM configured to generate a question response for an input question associated with a multiple-choice answer type. For example, an input question associated with a multiple-choice answer type, a set of input passages, and/or a set of temporal features corresponding to the set of input passages may be input to an encoder-based LLM during an inference phase to output a question response for the input question based on the set of input passages and/or set of temporal features. By way of example, the encoder-based LLM may be configured to efficiently and speedily perform classification tasks during an inference phase. During the modeling and/or training phase, a training input question and a set of training evidence passages (e.g., 5, 10, 20, etc. training evidence passages) from the annotated training set may be input to the encoder-based LLM to finetune the encoder-based LLM. The performance of the encoder-based LLM may depend on the manner in which the training evidence passages are selected. In this regard, in some embodiments, training evidence passages input to the encoder-based LLM are selected based on the output of the classification models. In this manner, during the modeling and/or training phase, the machine learning aggregation model is exposed to evidence passages that are highly relevant to the input question but may not include the answer to the input question.

In some embodiments, a decoder-based LLM is a finetuned decoder-based LLM configured to generate a question response for an input question associated with a large-limited-set answer type (e.g., left knee, right knee, Yes/No, both knees). For example, an input question associated with a large-limited-set answer type, a set of input passages, and/or a set of temporal features corresponding to the set of input passages may be input to a decoder-based LLM during an inference phase to output a question response for the input question based on the set of input passages and/or set of temporal features. During the modeling and/or training phase, a training input question and a set of training evidence passages from the annotated training set may be input to the decoder-based LLM to finetune the decoder-based LLM.

In some embodiments, a generative-pre-trained transformer model is configured to generate a question response for an input question associated with free-form answer type (e.g., e.g., how long the patient has been taking the medication?). An example of a generative-pre-trained transformer model is GPT-4.

In some embodiments, the term “relevance rank value” refers to a data entity that describes an ordered position of a data item within a group of data items. The ordered position, for example, may be based on a relevance criteria. For example, a group of evidence passages may be arranged in an order (e.g., ascending order, descending order, and/or the like) based on the relevance of each respective evidence passage to an input question, where the position of a respective evidence passage within the ordered group of evidence passages corresponds to the relevance rank value of the respective evidence passage. By way of example, relevance rank values may be outputted by a retrieval ensemble model.

In some embodiments, the term “evaluation module” refers to a computing entity configured to evaluate the results of the machine learning pipeline after an inference round. For example, the evaluation module may be configured to understand failed inferences (e.g., failed question scenarios) and to generate synthetic training passages for subsequent annotation or synthetic data generation rounds. In some embodiments, the evaluation module may include a retrieval scoring sub-module and an aggregation scoring sub-module.

In some embodiments, the term “retrieval scoring sub-module” refers to a computing entity that is configured to perform a portion of an evaluation operation associated with an evaluation module. For example, the retrieval scoring sub-module may be configured to generate one or more retrieval metrics to evaluate or otherwise assess the retrieval ensemble model, a portion thereof, or related processes.

In some embodiments, the term “retrieval metric” refers to a data entity that describes a metric for evaluating a retrieval ensemble model, a portion thereof, or related processes. A retrieval metric may be generated based on output of the retrieval ensemble model. For example, a retrieval metric may include a score such as mean reciprocal ranking (MRR) score, mean average precision (MAP) score, and/or the like based on relevance rank values associated with the evidence passages from a document set and the input question. In some embodiments, an MRR score is determined based on equation 1 below. For example, to determine the MRR score, the inverse of the relevance rank value of the first correct question response (“Q”) is calculated. The average of the reciprocal rank across all the input questions is then calculated and multiplied by the inverse of the relevance rank value of the first correct question response. In some embodiments, a MAP score corresponds to average precision (AveP) and is determined based on equation 2 below. In some embodiments, the MAP score (e.g., AveP) is based on the precision for the top k ranked evidence passages (P(k)) and a relevance function rel(k). The relevance function may describe an indicator function which equals “1” if the document at rank k is relevant and equals “0” otherwise.

$$MRR = \frac{1}{\vert Q \vert} {\sum }_{i = 1}^{\vert Q \vert} \frac{1}{{rank}_{i}} \qquad Equation 1$$

$$AveP = \frac{{\sum }_{k = 1}^{n} ( P ( k ) \times rel ( k ) )}{number of relevant documents} \qquad Equation 2$$

In some embodiments, the term “aggregation scoring sub-module” refers to a computing entity that is configured to perform a portion of an evaluation operation associated with an evaluation module. For example, the aggregation scoring sub-module may be configured to generate one or more aggregation metrics to evaluate or otherwise assess a machine learning aggregation model, portions thereof, or related process.

In some embodiments, the term “aggregation metric” refers to a data entity that describes a metric for evaluating a machine learning aggregation model, portions thereof, or related process. The aggregation metric may be indicative of the quality and/or accuracy of the machine learning aggregation model. In some examples the technique(s) utilized to generate an aggregation score for the machine learning aggregation model may depend on the type of model. In some embodiments, the aggregation metric for encoder-based LLMs include classification metrics such as precision, recall, accuracy and/or F1. In some embodiments, a bilingual evaluation understudy (BLEU) technique and/or a Recall-Oriented Understudy For Gisting Evaluation (ROUGE) technique may be leveraged to generate a BLEU score and/or a ROUGE score respectively for an encoder-based LLM. By way of example, each of the BLEU score and the ROUGE score may comprise numerical values between zero and one. The BLEU score and the ROUGE score may each be configured to measure the similarity between the question response output of the machine learning aggregation model and the ground truth. In some examples, ROUGE score may measure recall while the BLEU score may measure precision. In a clinical domain, when the ground truth final decision is available for a patient claim, the final decision may be predicted by generating a question response for the input question. The final decision may then be compared to the ground truth. The aggregation metrics may be provided in the form of classification metrics.

In some embodiments, the term “routing module” refers to a data entity that describes parameters, hyper-parameters, and/or defined operations of a rules-based algorithm and/or the like. For example, the routing module may be embodied by a machine learning aggregation model. The routing module may be configured to route an input set to a model of a multi-model architecture based on one or more criteria. For example, the routing model may be configured to route an input set comprising an input question and set of input passages to a sub-classification model of a machine learning aggregation model with a branched, multi-model architecture.

In some embodiments, the term “sub-classification model” refers to a classification model of a plurality of machine learning classification models of a branched multi-model architecture. For example, a sub-classification may include one of a plurality of machine learning models of an aggregation model (also referred to herein as aggregation model framework). In some embodiments, the sub-classification model includes one or more encoder-based LLMs and one or more decoder-based LLMs.

In some embodiments, the term “multi-model architecture” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). The multi-model architecture may include one or more of any type of machine learning model including one or more supervised, unsupervised, semi-supervised, reinforcement learning models, and/or the like. In some examples, the multi-model architecture may include one or more machine learning models configured, trained, and/or the like to individually or collectively generate a prediction for an input set. In some examples the input set to the multi-modal architecture may include output of one or more other models.

In some embodiments, the term “answer type” refers to a data entity that describes a category or grouping associated with a prospective response to an input question.

In some embodiments, the term “failure question scenario” refers to a data entity that describes an occurrence, where the result of an evaluation fails to satisfy one or more evaluation criteria. By way of example, a failure question scenario may describe an occurrence where an input question and selected input passage pair fail to satisfy one or more evaluation metrics (e.g., retrieval metrics, aggregation metrics, and/or the like).

In some embodiments, the term “synthetic data generation model” refers to a data entity that describes parameters, hyper-parameters, and/or defined operations of a rules-based and/or machine learning model (e.g., model including at least one of one or more rule-based layers, one or more layers that depend on trained parameters, coefficients, and/or the like). The synthetic data generation model may include one or more machine learning models configured, trained, and/or the like to generate synthetic training data. By way of example the synthetic data generation model may include one or more machine learning models configured, trained, and/or the like to generate synthetic training passages that form a subset of training passages for training and/or retraining of a retrieval ensemble model and/or a machine learning aggregation model.

For example, a pair of input question and input passage associated with the highest confidence but determined to be incorrect may be provided as input to the synthetic data generation model to output synthetic training passages while keeping the question response the same. The synthetic data generation model may, for example, comprise an LLM. In some embodiments, the synthetic data generation model may comprise a pre-trained generative AI model configured to receive various natural language input (e.g., prompt) such as, for example, “You are tasked to rewrite a context such that the answer to the given question doesn't change.” The synthetic data generation may be advantageous, particularly, in cases where there is inadequate data (e.g., for rare diseases in a clinical domain).

In some embodiments, the term “synthetic training passages” refers to a data entity that describes model output. For example, a synthetic training passage may describe the output of a synthetic data generation model. In some embodiments, the synthetic training passages comprises a rephrasing of the input passages and/or similar input passages. In an example implementation the synthetic training passages may be added to an existing training data set (e.g., annotated training set) and/or replace one or more training passages in the existing training data set for subsequent training and/or inference rounds. For example, an input passage from the input question and input passage pair determined to generate an incorrect response may be excluded during subsequent evaluation.

### IV. Overview

Various embodiments of the present disclosure provide improved query processing techniques that leverage modular machine learning pipelines to improve machine learning techniques traditionally used for understanding and processing complex queries. To do so, some embodiments of the present disclosure provide a modular machine learning pipeline that is configured to identify relevant evidence passages from a document set, score the relevant evidence passages, and then process the scored relevant evidence passages to resolve a query. By doing so, a traditionally single stage query resolution process may be divided into multiple stages (e.g., a retrieval and aggregation stages, etc.) to alleviate technical challenges that traditionally hinder the performance of traditional query processing techniques. As described herein, the modular machine learning pipeline may include multiple, connected machine learning models that are tailored to each stage of the multi-stage query resolution process. Each of the models may be trained at least partially individually and partially jointly to both specialize the models for a particular aspect of a query resolution process, while generalizing the machine learning pipeline to a vast number of different query types that may be processed within a complex query domain.

In some embodiments, a retrieval stage of a query resolution process is individually handled by a first set of models from the machine learning pipeline. The first set of models may include a retrieval ensemble model that is specially trained to extract passages from a document set for answering a particular input question. Due to the nature of machine learning and the diverse sets of question types in a complex query domain, different retrieval model architectures may exhibit varying degrees of retrieval performance depending on one or more attributes of an input question. For example, a first model architecture may perform well on extracting passages to answer input questions with temporal reasoning but may fail to extract relevant passages for answering input questions with semantic reasoning. To address this technical challenge in machine learning, the machine learning pipeline may include a retrieval ensemble model that include (1) a plurality of a different machine learning classification models configured according to different model architectures, training techniques, and/or the like and (2) a machine learning fusion model to weigh the relevance of passages extracted from each of the models based on the input question. In this way, each of the machine learning classification models may be tailored to a specific retrieval task and the machine learning fusion model may generalize the retrieval task to any type of potential retrieval task. By doing so, the retrieval ensemble model of the modular machine learning pipeline may outperform traditional, single-model baselines.

In some embodiments, a resolution stage of a query resolution process is individually handled by a second set of models from the machine learning pipeline. The second set of models may include one or more machine learning aggregation models that, as described with reference to the retrieval stage, may also be tailored to a particular resolution task. For example, the machine learning aggregation models may include an encoder-based and/or decoder-based LLM that may individually receive an input question and resolve the input question based on the weighted relevant passages extracted in the retrieval stage. In this way, the dynamic nature of the resolution stage enables a more powerful framework that assigns the best type of LLM for a particular resolution task. By doing so, the machine learning aggregation models of the modular machine learning pipeline may outperform traditional LLM-based query resolution techniques.

In a complex query domain, types of retrieval and query resolution tasks may be continuous in nature and dynamic change over time as additional queries are created. Traditional machine learning models are typically trained using static data that fails to account for these changes in a complex query domain. To address these technical challenges specific to machine learning, some of the techniques of the present disclosure may add a third stage to the traditional query resolution process. The third stage may include a continuous evaluation stage that may be handled by a third set of models from the machine learning pipeline. The third set of models may include one or more evaluation models and a synthetic data generation model that may collectively self-evaluate the performance of the modular machine learning pipeline and improve the performance of the modular machine learning pipeline through active learning. For example, to continuously ensure the accuracy of the question resolution techniques and account for new tasks, the one or more evaluation models may leverage one or more performance metrics to assess the output of the query resolution process. The one or more performance metrics may be leveraged by the synthetic data generation model to identify lower performing types of input questions. The questions may be provided to generative pre-trained transformer model to augment a training data set to improve the performance of the machine learning pipeline. By doing so, the continuous evaluation stage implemented by the modular machine learning pipeline may continuously improve the machine learning pipeline through exposure to a wide range of unlabeled data and scenarios.

Examples of technologically advantageous embodiments of the present disclosure include: (i) training data generation techniques for generating annotated training set, (ii) machine learning-based question resolution techniques for generating question responses, (iii) evaluation techniques for assessing the quality of question response outputs, (iii) machine learning models, and training techniques thereof, for generating and implementing a retrieval ensemble model and aggregation models, among other aspects of the present disclosure. Other technical improvements and advantages may be realized by one of ordinary skill in the art.

### V. Example System Operations

As indicated, various embodiments of the present disclosure make important technical contributions to generative text techniques. In particular, systems and methods are disclosed herein that implement a specially-configured machine learning pipeline for improving traditional machine learning-based query resolution processes. By doing so, the machine-learning pipeline may provide an improvement in machine learning that may be practically applied to improve various computing tasks, such as query understanding and resolution.

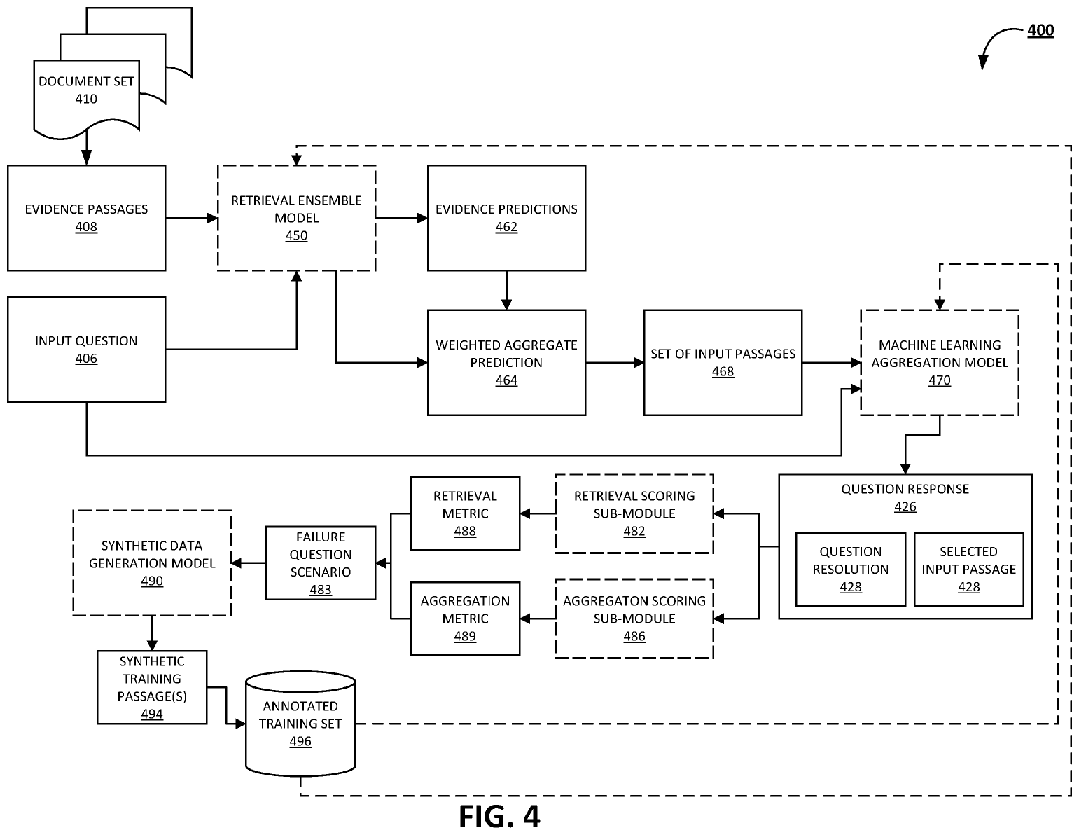

FIG. 4 is a dataflow diagram 400 showing example data structures and modules for generating a question response in accordance with some embodiments discussed herein. The dataflow diagram 400 illustrates a multi-stage text processing pipeline that is generalizable to a plurality of different types of input questions to allow for the automatic generation of a question response 426 for an input question 406 within a complex query domain. As described herein, the multi-stage text processing pipeline may include a plurality of connected models that are collectively configured to process the input question 406 and evidence passages 408 from a document set 410 to generate the question response 426. Unlike traditional text processing techniques, the multi-stage text processing pipeline is configured to programmatically generate the question response 426 for the input question 406 through a multi-stage process in which a sequence of connected models are leveraged to incrementally resolve the input question based on one or more evidence passages 408 from the document set 410. The multi-stage process, for example, may begin with a retrieval stage in which a retrieval ensemble model 450 may identify a plurality of relevant passages for the input question 406. As described herein, the retrieval stage may improve the question response 426 by providing a set of input passages 468 that are tailored to the later stages of the multi-stage process.

In some embodiments, a plurality of evidence passages 408 is received from a document set 410 corresponding to an input question 406. In some embodiments, the document set 410 is a collection of data items that describe one or more units of text (e.g., one or more words, sentences, phrases, etc.). For example, each data item of a collection of data items may include one or more portions of text in a structured format, unstructured format, semi-structured format, and/or combinations thereof. In some examples, a data item may describe a natural language document, such as a Portable Document Format (PDF) file and/or any other document type (e.g., Hyper-Text Markup Language (HTML) file, etc.). For instance, a data item may include a scanned physical document, an electronic record, and/or the like. The type of document or record may be based on the prediction domain. As examples, for a clinical domain, a data item may include a medical document, such as a medical chart, clinical notes, discharge summaries, and/or the like. In such a case, a document set 410 may include a plurality of medical documents that form a clinical history for a particular user.

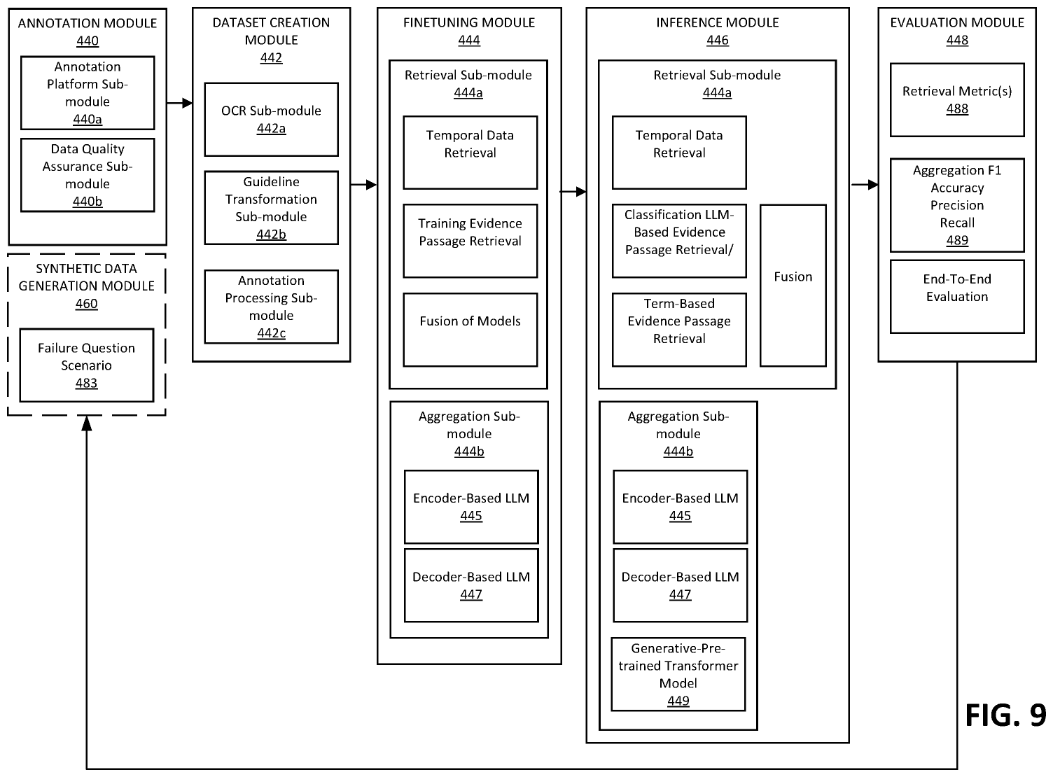

In some embodiments, the document set 410 includes a plurality of electronic representations of one or more documents. By way of example, the plurality of electronic representations may include a plurality of computer readable text that may be imaged and converted to computer readable text via one or more optical character recognition (OCR) techniques. In this manner, a dataset creation module 442 (See FIG. 9) may be configured to covert an image, such as scanned PDF document, into a format that is consumable by one or more models of the present disclosure. In some embodiments, the document set 410 is decomposed into one or more individual text segments that may be analyzed individually and/or in one or more combinations using some of the techniques of the present disclosure. An individual text segment, for example, may include an evidence passage for generating a predictive output.

In some embodiments, an evidence passage is an individual text segment from a document set 410. For example, an evidence passage may include a portion of a natural language document that includes a segment of text, such as one or more phrases, one or more sentences, one or more paragraphs, and/or the like from the document set 410. In some examples, the plurality of evidence passages 408 may be extracted from the document set 410. Each evidence passage 408 may be individually processed (e.g., by one or more models of the present disclosure) to generate a predictive output for the input question 406.

In some embodiments, the input question 406 is a data entity that describes a request for information associated with the document set 410. The input question 406, for example, may include a structured and/or unstructured complex query associated with a predefined criteria set. For instance, a predefined criteria set may include one or more comprehensive requirements for an overall predictive output. The predefined criteria set, for example, may include a sequence of logical functions that define one or more partially dependent requirements of the overall predictive output. The predefined criteria set may be decomposed into a plurality of input questions. Each input question may include structured and/or unstructured text that defines a question (e.g., a binary question, a categorical question, etc.) that may be answered using information from the document set 410. An overall prediction output may be generated by processing a series of input questions to satisfy at least a subset of the predefined criteria set for the overall predictive output. In some examples, a plurality of input questions may correspond to a single criterion of the predefined criteria set. For example, criterion that may include a plurality of predefined options (e.g., a multi-choice question, etc.) may be decomposed into individual input questions that respectively correspond to the plurality of predefined options.

In some embodiments, the input question 406 originates from or is otherwise extracted from one or more criteria documents, such as guideline documents, knowledge library documents, standard operation procedures, and/or the like. By way of example, in a clinical domain, an overall predictive output may correspond to a medical necessity check that is structured as a series of checklists. Each checklist may be presented in either a simple, straightforward format or a more complex, hierarchical arrangement, such as decision trees. The overall predictive output (e.g., a final decision) for the medical necessity check may be a logical function of the checked items in the checklist or the selected branches in the decision tree. In such a case, the input question 406 may include request for information to complete an item from the checklist, a node from a decision tree, and/or the like.

In a clinical domain and/or any other predictive domain with complex criteria sets, the complexity and diversity of the criteria sets, such as clinical guidelines, and the long length along with the longitudinal nature of corresponding document sets, such as medical charts, impose numerous challenges on this task. For instance, one guideline may contain questions that require temporal reasoning (e.g., has the patient received any analgesic in the last 3 months), and another one may need reasoning about negation (e.g., the patient has none of arthritis, joint subluxation, or subchondral cysts). These challenges make monolithic machine learning solutions to this problem less desirable. In contrast a modular approach that may treat different challenges independently is more generalizable to new guideline question types.

In some embodiments, the input question 406 includes a query for information from the document set 410 and logic for determining whether the document set 410 (and/or a user associated therewith) satisfies a criterion based on the information. For example, a predictive output for the input question 406 may include a question response 426 that is based on information extracted from the document set 410 and includes a determination of whether the document set 410 (and/or a user associated therewith) satisfies a criterion.

In some embodiments, the question response 426 is a data entity that describes a predictive output for the input question 406. The question response 426 may include one or more natural language terms and/or phrases that represents an answer to the input question 406. Additionally or alternatively, the question response 426 may include one or more evidence passages that support the answer to the input question 406. For example, the question response 426 may include a question resolution 428 and an evidence passage from the document set 410 that was leveraged to generate the question resolution 428. The question resolution 428, for example, may include a binary, categorical, natural language, and/or any other form of response to an input question 406. In some examples, the question resolution 428 may be generated by a machine learning pipeline that may identify the plurality of evidence passages 408 from the document set 410 for the input question 406, select an evidence passage for answering the input question 406, and generate the question resolution 428 based on the selected evidence passage. In some examples, the selected evidence passage may be provided as support for the question resolution 428.

In some embodiments, the machine learning pipeline is to a data entity that describes a sequence of computing tasks for generating a question response from an input question. In some examples, the machine learning pipeline may include a plurality of connected modules configured to perform one or more operation associated with a multi-stage machine-learning process. The multi-stage process, for example, may include a plurality of training and inference phases for training, implementing, and continuously retraining one or more machine learning models. The plurality of connected modules, for example, may include (i) an annotation module 440 configured to provide manual labels for training documents given a training question, (ii) a dataset creation module 442 configured to generate a document set, (iii) a fine-tuning module 444 configured to train a retrieval ensemble model 450 and/or machine learning aggregation model 470 for performing one or more portions of a question resolution process, (iv) an inference module 446 configured to implement the trained retrieval ensemble model 450 and/or machine learning aggregation model 470 to perform the one or more portions of the question resolution process, (v) evaluation module 448 configured to evaluate one or more predictive outputs of the question resolution process and, based on the evaluation, initiate one or more retraining operations, and/or (vi) a synthetic data generation module 460 configured to generate synthetic training (See FIG. 9).

In some embodiments, a plurality of evidence predictions 462 for an evidence passage of the plurality of evidence passages 408 is generated based on the input question 406 and using a retrieval ensemble model 450. In some embodiments, the retrieval ensemble model 450 comprises a plurality of classification models and a machine learning fusion model. In some embodiments, the plurality of classification models comprises a term-based retrieval model and one or more different classification LLMs. In some embodiments, the plurality of classification models and the machine learning fusion model are jointly trained using a subset of an annotated training set 496. In some embodiments, the plurality of evidence predictions 462 for an evidence passage comprises a plurality of relevance rank values that each reflect a relevance of the evidence passage to the input question 406 relative to the plurality of evidence passages 408.

In some embodiments, a relevance rank value is a data entity that describes an ordered position of a data item within a group of data items. The ordered position, for example, may be based on a relevance criteria. For example, a group of evidence passages may be arranged in an order (e.g., ascending order, descending order, and/or the like) based on the relevance of each respective evidence passage to an input question, where the position of a respective evidence passage within the ordered group of evidence passages corresponds to the relevance rank value of the respective evidence passage. By way of example, relevance rank values may be outputted by a retrieval ensemble model.

In some embodiments, the retrieval ensemble model 450 is a data entity that describes parameters, hyper-parameters, and/or defined operations of a rules-based and/or machine learning model (e.g., model including at least one of one or more rule-based layers, one or more layers that depend on trained parameters, coefficients, and/or the like). The retrieval ensemble model 450 may include one or more of any type of machine learning model including one or more supervised, unsupervised, semi-supervised, reinforcement learning models, and/or the like. For example, the retrieval ensemble model 450 may include multiple models configured to individually and/or collectively perform one or more stages of a question resolution process. For example, the multiple models may be trained at least partially end-to-end and/or individually to generate a weighted aggregate prediction for an evidence passage from a document set based on an input question. In some examples, the weighted aggregate prediction may be aggregated from a plurality of intermediate evidence predictions for the evidence passage.

For example, the retrieval ensemble model 450 may include a plurality of classification models and a machine learning fusion model. The plurality of classification models may be configured (e.g., trained, etc.) to respectively generate a plurality of evidence predictions for an evidence passage based on an input question. The plurality of evidence predictions may be input to the connected machine learning fusion model to generate a weighted aggregate prediction for the evidence passage. In this manner, the retrieval ensemble model may be configured, trained, and/or the like to (i) generate a plurality of evidence predictions for an evidence passage with respect to an input question (e.g., using one or more classification models thereof, etc.) and (ii) generate a weighted aggregate prediction for an evidence passage based on plurality of evidence predictions (e.g., using a machine learning fusion model thereof, etc.).

In some embodiments, a classification model is a data entity that describes parameters, hyper-parameters, and/or defined operations of a rules-based algorithm and/or machine learning model (e.g., model including at least one or more rule-based layers, one or more layers that depend on trained parameters, coefficients, and/or the like), and/or the like. A classification model may include any type of model configured, trained, and/or the like to generate an evidence prediction for an evidence passage. A classification model may include one or more of any type of machine learning model including one or more supervised, unsupervised, semi-supervised, reinforcement learning models, and/or the like. In some examples, the retrieval ensemble model 450 includes one or more different classification models of different types. For instance, a first classification model may include a term-based retrieval model and one or more second classification models may include one or more different classification LLMs.

In some embodiments, a classification model is configured to generate an evidence prediction. For example, during a training and/or modeling phase, the evidence prediction may include a positive relevance classification or a negative relevance classification. By way of example, a classification model may be previously trained to classify an evidence passage into the predefined category and/or assign a relevance rank value to the evidence passage. In some examples, the classification model may be trained (e.g., via back-propagation of errors, etc.) individually and/or jointly with one or more other models using an annotated training set 496. For example, a classification model may be jointly trained with one or more machine learning fusion models using a plurality of annotated training document sets. The machine learning fusion model may be configured to dictate or otherwise determine the ensemble weights for each classification model (e.g., term-based retrieval model, classification LLM, etc.). A classification model may be configured to receive an input question and one or more evidence passages during an inference phase and rank the evidence passages based on their relevance to the input question. In some embodiments, the noted ranking task may take the form of a classification task during modeling and/or training phase where a training evidence passage that is related to a training input question is assigned a positive relevance label (e.g., “1”) and a training evidence passage that is not related to the input question is assigned a negative relevance label (e.g., “0”). For example, during a modeling and/or training phase, a classification model may be finetuned using the annotated training set 496 to assign a training evidence passage a positive label or a negative label based on the relevance of the training input question to the training evidence passages.

As described above, the plurality of classification models may include a term-based retrieval model and one or more different classification LLMs. In some embodiments, the term-based retrieval model is a type of classification model. The term-based retrieval model may be configured to process natural language text to generate an output. In some examples, a term-based retrieval model may include a rule-based and/or machine learning model. In some embodiments, the term-based retrieval model may be configured to generate an output based on keyword matching and may not require finetuning. In this regard, the term-based retrieval model may provide for retrieving evidence passages that may be semantically different from the input question 406 but share keywords with the input question 406. As one example, the term-based retrieval model may include a ranking algorithm, such as a bag-of-words function, that ranks an evidence passage by matching natural language text of the evidence passage to an input question. By way of example, the term-based retrieval model may include a BM25 model, Term Frequency-Inverse Document Frequency (TF-IDF) model, and/or the like. The term-based retrieval model may be configured to rank evidence passages based on their relevance to the input question 406 and output the top N ranked evidence passages, where N may be any number (e.g., 2 5, 7, 20, etc.). For example, during an inference phase, one or more evidence passages may be input to the term-based retrieval model to output the top N ranked relevant evidence passages of the one or more evidence passages.

In some embodiments, a classification LLM is a type of classification model. A classification LLM, for example, may be configured to process natural language text, using one or more machine learning techniques, to generate an output. In some examples, a classification LLM may include an LLM, such as one or more generative pre-trained transformers, BERT, T5, robustly optimized BERT, and/or the like. In some examples, a classification LLM may be at least partially finetuned using the annotated training set 496.

In some embodiments, an evidence prediction refers to a data entity that describes a classification model output. For example, an evidence prediction may be an intermediate output of the retrieval ensemble model 450. An evidence prediction may describe a predicted likelihood of relevance of an evidence passage to an input question. For example, an evidence prediction may be indicative of a likelihood that an evidence passage includes data/information that may answer an input question and/or support an answer to an input question). An evidence prediction may be generated using classification LLMs, term-based retrieval models, and/or the like, which may form a subset of the retrieval ensemble model 450.

In some embodiments, a weighted aggregate prediction 464 for an evidence passage is generated based on the plurality of evidence predictions 462 and using the retrieval ensemble model 450. In some embodiments, the machine learning fusion model of the retrieval ensemble model 450 is previously trained to generate the weighted aggregate prediction 464 from the plurality of evidence predictions 462 based on a correspondence between the plurality of classification models of the retrieval ensemble model 450 and the input question 406.

In some embodiments, the weighted aggregate prediction 464 is a data entity that describes a measure of a weighted combination of prediction outputs from one or more classification models. For example, the weighted aggregate prediction may describe a measure of a weighted combination of evidence predictions for an evidence passage that are individually output by one or more classification models. In some examples, the weight values applied to the prediction outputs to generate the weighted aggregate prediction may be learned by the machine learning fusion model.

In some embodiments, a set of input passages 468 from the plurality of evidence passages 408 is selected based on the weighted aggregate prediction 464. In some embodiments, the set of input passages 468 is a data entity that describes a model input. The set of input passages 468 may include one or more evidence passages from the document set 410 that are determined, via execution of the machine learning pipeline, to be relevant (e.g., most relevant) for generating a question response for the input question 406. For example, the set of input passages 468 may be selected from one or more evidence passages based on the weighted aggregate prediction 464 associated with each of the one or more evidence passages.

In some embodiments, a question response 426 is generated using a machine learning aggregation model 470 and based on the set of input passages 468 and the input question 406.

In some embodiments, the machine learning aggregation model 470 is a data entity that describes parameters, hyper-parameters, and/or defined operations of a rules-based algorithm and/or machine learning model (e.g., model including at least one or more rule-based layers, one or more layers that depend on trained parameters, coefficients, and/or the like), and/or the like. The machine learning aggregation model 470 may be configured to process the set of input passages 468 in order to generate the question response 426 for the input question 406. By way of example, the machine learning aggregation model 470 may be configured, trained, and/or the like to process a set of one or more input passages output from a retrieval ensemble model to generate a question response for an input question. The machine learning aggregation model 470 may include one or more of any type of machine learning model including one or more supervised, unsupervised, semi-supervised, reinforcement learning models, and/or the like. In some examples, the machine learning aggregation model 470 may include multiple models configured to perform one or more different stages of a prediction process. In some examples, the machine learning aggregation model 470 may include a branched, multi-model architecture. By way of example, the machine learning aggregation model may include one or more sub-classification models, one or more generative-pre-trained transformer model, one or more routing modules, and/or the like. In some embodiments, the one or more sub-classification models include one or more encoder-based LLMs and/or one or more decoder-based LLMs. In some embodiments, a routing module may be configured to route an input question and set of input passages to an encoder-based LLM or decoder-based LLM based on the answer type associated with the input question.

In some embodiments, an answer type is a data entity that describes a category or grouping associated with a prospective response to an input question.

In some embodiments, a sub-classification model is a classification model of a plurality of machine learning classification models of a branched multi-model architecture. For example, a sub-classification may include one of a plurality of machine learning models of an aggregation model (also referred to herein as aggregation model framework). In some embodiments, an input question and set of input passages may be routed to an encoder-based LLM or decoder-based LLM based on the answer type associated with the input question.

In some embodiments, the routing module is a data entity that describes parameters, hyper-parameters, and/or defined operations of a rules-based algorithm and/or the like. For example, the routing module may be embodied by the machine learning aggregation model 470. The routing module may be configured to route an input set to a model of a multi-model architecture based on one or more criteria. For example, the routing model may be configured to route an input set comprising an input question and set of input passages to a sub-classification model of the machine learning aggregation model 470 with a branched, multi-model architecture.

In some embodiments, a multi-model architecture is a data entity that describes parameters, hyper-parameters, and/or defined operations of a rules-based and/or machine learning model (e.g., model including at least one of one or more rule-based layers, one or more layers that depend on trained parameters, coefficients, and/or the like). The multi-model architecture may include one or more of any type of machine learning model including one or more supervised, unsupervised, semi-supervised, reinforcement learning models, and/or the like. In some examples, the multi-model architecture may include one or more machine learning models configured, trained, and/or the like to individually or collectively generate a prediction for an input set. In some examples the input set to the multi-modal architecture may include output of one or more other models.

In some embodiments, an encoder-based LLM is a finetuned encoder-based LLM configured to generate a question response for an input question associated with a multiple-choice answer type. For example, an input question associated with a multiple-choice answer type, a set of input passages, and/or a set of temporal features corresponding to the set of input passages may be input to an encoder-based LLM during an inference phase to output a question response for the input question based on the set of input passages and/or set of temporal features. By way of example, the encoder-based LLM may be configured to efficiently and speedily perform classification tasks during an inference phase. During the modeling and/or training phase, a training input question and a set of training evidence passages (e.g., 5, 10, 20, etc. training evidence passages) from the annotated training set 496 may be input to the encoder-based LLM to finetune the encoder-based LLM. The performance of the encoder-based LLM may depend on the manner in which the training evidence passages are selected. In this regard, in some embodiments, training evidence passages input to the encoder-based LLM are selected based on the output of the classification models. In this manner, during the modeling and/or training phase, the machine learning aggregation model is exposed to evidence passages that are highly relevant to the input question but may not include the answer to the input question.

In some embodiments, a decoder-based LLM is a finetuned decoder-based LLM configured to generate a question response for an input question associated with a large-limited-set answer type (e.g., left knee, right knee, Yes/No, both knees). For example, an input question associated with a large-limited-set answer type, a set of input passages, and/or a set of temporal features corresponding to the set of input passages may be input to a decoder-based LLM during an inference phase to output a question response for the input question based on the set of input passages and/or set of temporal features. During the modeling and/or training phase, a training input question and a set of training evidence passages from the annotated training set 496 may be input to the decoder-based LLM to finetune the decoder-based LLM.

In some embodiments, a generative-pre-trained transformer model is configured to generate a question response for an input question associated with free-form answer type (e.g., e.g., how long the patient has been taking the medication?). An example of a generative-pre-trained transformer model is GPT-4.

In some embodiments, a retrieval metric 488 is generated for the question response 426 based on the selected input passage and using a retrieval scoring sub-module 482.

In some embodiments, the retrieval scoring sub-module 482 is a computing entity that is configured to perform a portion of an evaluation operation associated with an evaluation module. For example, the retrieval scoring sub-module may be configured to generate one or more retrieval metrics to evaluate or otherwise assess the retrieval ensemble model 450, a portion thereof, or related processes.

In some embodiments, the retrieval metric 488 is a data entity that describes a metric for evaluating a retrieval ensemble model, a portion thereof, or related processes. A retrieval metric may be generated based on output of the retrieval ensemble model. For example, a retrieval metric may include a score such as mean reciprocal ranking (MRR) score, mean average precision (MAP) score, and/or the like based on relevance rank values associated with the evidence passages from a document set and the input question. In some embodiments, the MRR score is determined based on equation 1 below.

$$MRR = \frac{1}{\vert Q \vert} {\sum }_{i = 1}^{\vert Q \vert} \frac{1}{{rank}_{i}} \qquad Equation 1$$

For example, to determine the MRR score, the inverse of the relevance rank value of the first correct question response (“Q”) is calculated. The average of the reciprocal rank across all the input questions is then calculated and multiplied by the inverse of the relevance rank value for the first correct question response.

In some embodiments, a MAP score corresponds to average precision (AveP) and is determined based on equation 2 below,

$$AveP = \frac{{\sum }_{k = 1}^{n} ( P ( k ) \times rel ( k ) )}{number of relevant documents} \qquad Equation 2$$

In some embodiments, the MAP score (e.g., AveP) is based on the precision for the top k ranked evidence passages (P(k)) and a relevance function rel(k). The relevance function may describe an indicator function which equals “1” if the document at rank k is relevant and equals “0” otherwise.

In some embodiments, an aggregation metric 489 for the question response 426 is generated using an aggregation scoring sub-module 486 and based on the question resolution 428.

In some embodiments, the aggregation scoring sub-module is a computing entity that is configured to perform a portion of an evaluation operation. For example, the aggregation scoring sub-module may be configured to generate one or more aggregation metrics to evaluate or otherwise assess a machine learning aggregation model, portions thereof, or related process.

In some embodiments, the aggregation metric is a data entity that describes a metric for evaluating a machine learning aggregation model, portions thereof, or related process. The aggregation metric may be indicative of the quality and/or accuracy of the machine learning aggregation model. In some examples the technique(s) utilized to generate an aggregation score for the machine learning aggregation model may depend on the type of model. In some embodiments, the aggregation metric for encoder-based LLMs include classification metrics such as precision, recall, accuracy and/or F1. In some embodiments, a bilingual evaluation understudy (BLEU) technique and/or a Recall-Oriented Understudy For Gisting Evaluation (ROUGE) technique may be leveraged to generate a BLEU score and/or a ROUGE score respectively for an encoder-based LLM. By way of example, each of the BLEU score and the ROUGE score may comprise numerical values between zero and one. The BLEU score and the ROUGE score may each be configured to measure the similarity between the question response output of the machine learning aggregation model and the ground truth. In some examples, the ROUGE score may measure recall while the BLEU score may measure precision. In a clinical domain, when the ground truth final decision is available for a patient claim, the final decision may be predicted by generating a question response for the input question. The final decision may then be compared to the ground truth. The aggregation metrics may be provided in the form of classification metrics.

In some embodiments, one or more active training operations for the retrieval ensemble model and the machine learning aggregation model is initiated based on the retrieval metric and the aggregation metric.

In some embodiments, a failure question scenario 483 is identified based on the input question, the retrieval metric, and/or the aggregation metric.

In some embodiments, a failure question scenario 483 refers to a data entity that describes an occurrence, where the result of an evaluation (e.g., performed via the evaluation module) fails to satisfy one or more evaluation criteria. By way of example, a failure question scenario may describe an occurrence where an input question and selected input passage pair fail to satisfy one or more evaluation metrics (e.g., retrieval metrics, aggregation metrics, and/or the like).

In some embodiments, responsive to the failure question scenario, a plurality of synthetic training passages 494 is generated from the set of input passages 468 using a synthetic data generation model 490.

In some embodiments, a synthetic data generation model 490 is a data entity that describes parameters, hyper-parameters, and/or defined operations of a rules-based and/or machine learning model (e.g., model including at least one of one or more rule-based layers, one or more layers that depend on trained parameters, coefficients, and/or the like). The synthetic data generation model may include one or more machine learning models configured, trained, and/or the like to generate synthetic training data. By way of example the synthetic data generation model may include one or more machine learning models configured, trained, and/or the like to generate synthetic training passages that form a subset of training passages for training and/or retraining of a retrieval ensemble model and/or a machine learning aggregation model.

For example, a pair of input question and input passage associated with the highest confidence but determined to be incorrect may be provided as input to the synthetic data generation model 490 to output synthetic training passages while keeping the question response the same. The synthetic data generation model 490 may, for example, comprise an LLM. In some embodiments, the synthetic data generation model may comprise a pre-trained generative AI model configured to receive various natural language input (e.g., prompt) such as, for example, “You are tasked to rewrite a context such that the answer to the given question doesn't change.” The synthetic data generation may be advantageous, particularly, in cases where there is inadequate data (e.g., for rare diseases in a clinical domain).

In some embodiments, synthetic training passages is a data entity that describes model output. For example, the synthetic training passages 494 may describe the output of the synthetic data generation model 490. In some embodiments, the synthetic training passages 494 comprises a rephrasing of the input passages and/or similar input passages. In an example implementation the synthetic training passages 494 may be added to an existing training data set (e.g., annotated training set 496) and/or replace one or more training passages in the existing training data set for subsequent training and/or inference rounds. For example, an input passage from the input question and input passage pair determined to generate an incorrect response may be excluded during subsequent evaluation.

In some embodiments, one or more targeted training operations is initiated based on the plurality of synthetic training passages.

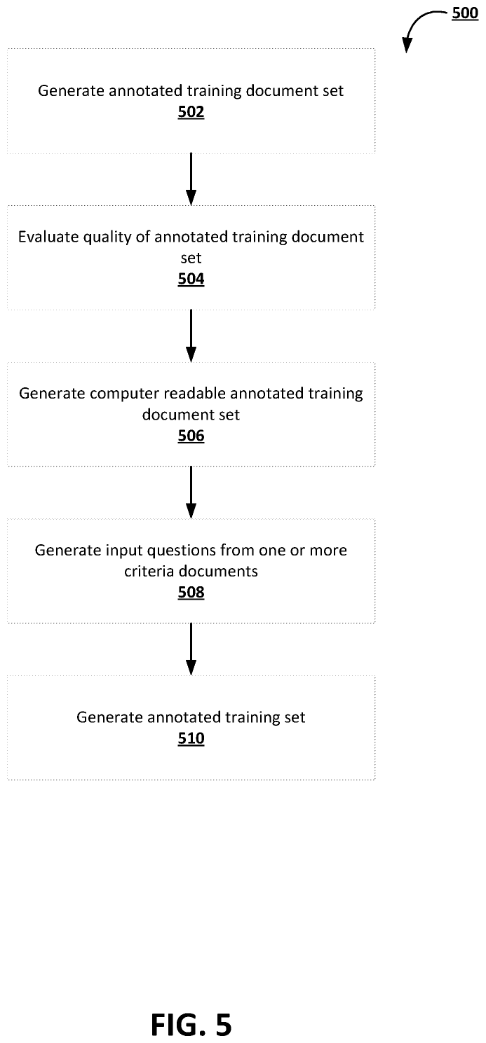

FIG. 5 is a flowchart diagram of an example process 500 for generating annotated training set for a machine learning pipeline in accordance with some embodiments discussed herein. The flowchart depicts a training dataset creation process 500 which may be leveraged to finetune one or more models associated with machine learning pipeline techniques described herein. The process 500 may be implemented by one or more computing devices, entities, and/or systems described herein. For example, via the various steps/operations of the process 500, the computing system 101 may leverage annotation, quality assessment, and document transformation techniques to generate annotated training set for a machine learning pipeline. By doing so, the process 500 enables the generation of training data that ensuring data quality.

FIG. 5 illustrates an example process 500 for explanatory purposes. Although the example process 500 depicts a particular sequence of steps/operations, the sequence may be altered without departing from the scope of the present disclosure. For example, some of the steps/operations depicted may be performed in parallel or in a different sequence that does not materially impact the function of the process 500. In other examples, different components of an example device or system that implements the process 500 may perform functions at substantially the same time or in a specific sequence.

In some embodiments, the process 500 includes, at step/operation 502, generating annotated training document set (e.g., labeled training document set). For example, the computing system 101 may generate a plurality of annotated training document sets using an annotation module. For example, the computing system 101 may leverage one or more annotators to generate the plurality of training document sets. An annotated training document set may comprise a set of training questions along with selected training question responses and training evidence passages for the set of training questions.

In some embodiments, the process 500 includes, at step/operation 504, evaluate the accuracy/quality of the annotated training document set. For example, the computing system 101 may evaluate the accuracy/quality of the annotated training document set using the annotation module. For example, the computing system 101 may flag mis-labeled/inaccurate portions of the annotated training document set based on an accuracy/quality threshold. For example, the computing system 101 may flag portions of the training document set that fails to satisfy a predetermined accuracy/quality threshold. In some embodiments, the portions of the annotated training document set that fails to satisfy the accuracy/quality threshold are re-input relabeled and/or arbitrated.

In some embodiments, the process 500 includes at step/operation 506, generate computer readable annotated training document set. For example, the computing system 101 may convert one or more data items from a document set to computer readable text. For example, the one or more data items may describe a natural language document, such as PDF file, and/or any other document type (e.g., Hyper-Text Markup Language (HTML) file, etc.). As examples, for a clinical domain, a data item may include a medical document, such as a medical chart, clinical notes, discharge summaries, and/or the like. The computing system 101 may convert the one or more data items to a computer readable text using one or more OCR techniques.

In some embodiments, the process 500 includes at step/operation 508, generating input questions from one or more criteria documents, such as guideline documents, knowledge library documents, standard operation procedures, and/or the like. In some embodiments, the computing system 101 decomposes a plurality of input questions corresponding to a single criterion (such as a multi-choice question) from the domain document set, into individual input questions.

In some embodiments, the process 500 includes at step/operation 510, generating an annotated training set. For example, the computing system 101 may generate the annotated training set by aggregating the plurality of annotated training document set from the plurality of annotators based on one or more criteria. For example, the computing system 101 may determine and select the union of the annotated training document set outputs (e.g., training evidence passages and selected question responses) to generate the annotated training set.

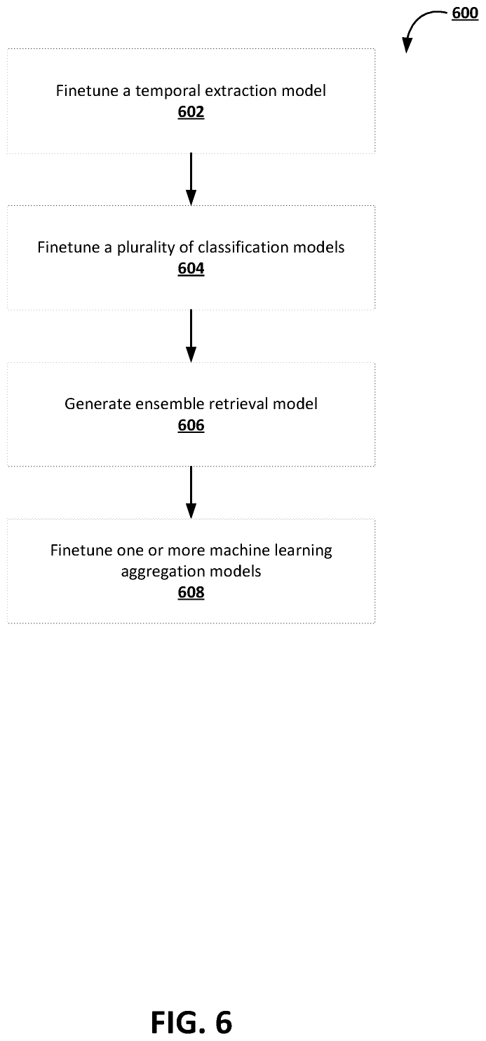

FIG. 6 is a flowchart diagram of an example process 600 for training models of a machine learning pipeline in accordance with some embodiments discussed herein. The flowchart depicts a finetuning process 600 for improving the performance of a question resolution process as described herein. The process 600 may be implemented by one or more computing devices, entities, and/or systems described herein. For example, via the various steps/operations of the process 600, the computing system 101 may leverage one or more finetuning techniques to generate one or more machine learning models.

FIG. 6 illustrates an example process 600 for explanatory purposes. Although the example process 600 depicts a particular sequence of steps/operations, the sequence may be altered without departing from the scope of the present disclosure. For example, some of the steps/operations depicted may be performed in parallel or in a different sequence that does not materially impact the function of the process 600. In other examples, different components of an example device or system that implements the process 600 may perform functions at substantially the same time or in a specific sequence.

In some embodiments, the process includes at step/operation 602, finetuning a temporal extraction model. For example, the computing system 101 may finetune the temporal extraction model to receive, as input, an evidence passage from a document set and process the evidence passage to output a set of temporal features associated with the evidence passage. In some embodiments, the computing system 101 may finetune the temporal extraction model based on a set of temporal features obtained from an annotator and/or an LLM. For example, the temporal extraction model may comprise an efficient and computationally inexpensive LLM finetuned using a set of temporal features obtained from one or more annotators and/or a powerful but computationally expensive LLM.

In some embodiments, the process includes at step/operation 604, finetuning a plurality of classification models. For example, the computing system 101 may finetune a classification model to receive an input set comprising an input question and a plurality of evidence passages from a document set and process the input set to generate a plurality of evidence predictions. In some embodiments, the plurality of evidence predictions for an evidence passage comprises a plurality of relevance rank values that each reflect a relevance of an evidence passage to the input question relative to the plurality of evidence passages. For example, the computing system 101 may finetune a classification model to rank an evidence passage with respect to an input question based on the relevance of the evidence passage to the input question.

In some embodiments, the process includes at step/operation 606, generating an ensemble retrieval model. For example, the computing system 101 may finetune the weights of the classification models based on the annotated training set (e.g., a subset thereof) to create the retrieval ensemble model. In some embodiments, the computing system 101 leverages a machine learning fusion model to generate a weighted aggregate prediction of the prediction outputs (e.g., evidence prediction outputs) from the classification models.

In some embodiments, the process includes at step/operation 608, finetuning one or more machine learning aggregation models. In some embodiments, the one or more machine learning aggregation models comprise one or more encoder-based LLMs and/or one or more decoder-based LLMs. For example, the computing system 101 may finetune the machine learning aggregation model based one or more training input sets, each comprising a training input question and a set of training evidence passages. In some embodiments, the set of training evidence passages is selected based on the output of the finetuned encoder-based models and/or finetuned decoder-based models. In this manner the machine learning aggregation module is exposed to evidence passages that are highly relevant to the input question but may not include the answer to the input question.

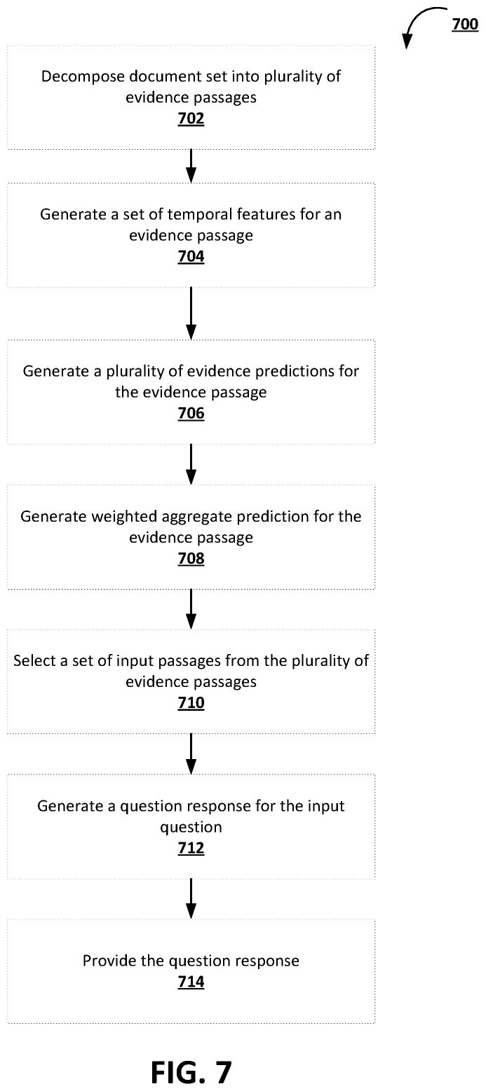

FIG. 7 is a flowchart diagram of an example process 700 for generating a question response in accordance with some embodiments discussed herein. The flowchart depicts a machine learning-based question resolution process 700 for improving question resolution operations with respect to diverse use cases. The process 700 may be implemented by one or more computing devices, entities, and/or systems described herein. For example, via the various steps/operations of the process 700, the computing system 101 may leverage one or more of a temporal extraction model, a retrieval ensemble model and machine learning aggregation module to generate a question response for an input question.

FIG. 7 illustrates an example process 700 for explanatory purposes. Although the example process 700 depicts a particular sequence of steps/operations, the sequence may be altered without departing from the scope of the present disclosure. For example, some of the steps/operations depicted may be performed in parallel or in a different sequence that does not materially impact the function of the process 700. In other examples, different components of an example device or system that implements the process 700 may perform functions at substantially the same time or in a specific sequence.

In some embodiments, the process 700 includes at step/operation 702, decomposing a document set into a plurality of evidence passages. For example, the computing system 101 may decompose the document set into a plurality of overlapping evidence passages. The document set may comprise a collection of data items that, where each data item of the collection of data items may include one or more portions of text in a structured format, unstructured format, semi-structured format, and/or combinations thereof. In some examples, a data item may describe a natural language document. The type of document or record may be based on the prediction domain. As examples, for a clinical domain, a data item may include a medical document, such as a medical chart, clinical notes, discharge summaries, and/or the like.

In some embodiments, the process 700 includes at step/operation 704, generating a set of temporal features for an evidence passage. For example, the computing system 101 may generate a set of temporal features for each evidence passage from the document set using a temporal extraction model. By way of example, a temporal feature may include a timestamp (e.g., date, time, and/or the like) associated with the occurrence of an event. In a clinical domain, the temporal data feature may include a date and/or time of a clinical visit, laboratory visit, and/or the like. By way of example, one or more LLMs may be configured, trained, and/or the like to receive an evidence passage as input and output a temporal data feature for the evidence passage.

In some embodiments, the process 700 includes at step/operation 706, generating, a plurality of evidence predictions for the evidence passage. For example, the computing system 101 may generate a plurality of evidence predictions for each evidence passage of the plurality of evidence passages based on an input question. The computing system 101 may generate the plurality of evidence predictions for the evidence passage using a retrieval ensemble model. For example, the computing system 101 may generate the plurality of evidence predictions for an evidence passage using one or more classifications models. The one or more classification models may comprise a term-based retrieval model and/or one or more classification LLMs. In some embodiments, the plurality of evidence predictions for the evidence passage comprises a plurality of relevance rank value. Each relevance rank value may reflect a relevance of the evidence passage to the input question relative to the plurality of evidence passages.

In some embodiments, the process 700 includes at step/operation 708, generating a weighted aggregate prediction for the evidence passage. For example, the computing system 101 may generate a weighted aggregate prediction for the evidence passage based on the plurality of evidence predictions output from the retrieval ensemble model. The computing system 101 may generate the weighted aggregate prediction for the evidence passage using the retrieval ensemble model. For example, the computing system 101 may generate the weighted aggregate prediction for the evidence passage using the machine learning fusion model of the retrieval ensemble model. For example, the machine learning fusion model may be previously trained to generate the weighted aggregate prediction from the plurality of evidence predictions based on a correspondence between the plurality of classification models and the input question.

In some embodiments, the process includes at step/operation 710, selecting, a set of input passages from the plurality of evidence passages. For example, the computing system 101 may select a set of input passages from the plurality of evidence passages based on the weighted aggregate prediction associated with each evidence passage.

In some embodiments, the process includes at step/operation 712, generating a question response for the input question. For example, the computing system 101 may generate a question response based on the set of input passages and the input question. The computing system 101 may generate the question response using a machine learning aggregation model. For example, the machine learning aggregation model may be previously trained to generate a question response for an input set comprising an input question and a set of input passages. The question response may comprise a question resolution and a selected input passage from the set of input passages that corresponds to the question resolution.

In some embodiments, the machine learning aggregation model comprises a branched, multi-model architecture. The branched multi-model architecture may define (i) one or more sub-classification models comprising one of an encoder-based LLM, a decoder-based LLM, or a generative pre-trained transformer model and (ii) a routing module. The routing model may be configured to route an input to one of the one or more sub-classification models. For example, generating the question response may comprise routing, using the routing module, the input question and the set of input passages to a selected sub-classification model of one or more sub-classification models defined by the branched, multi-model architecture based on an answer type corresponding to the input question.

In some embodiments, the process 700 includes at step/operation 714, providing the question response. For example, the computing system 101 may provide the question response to one or more computing entities.

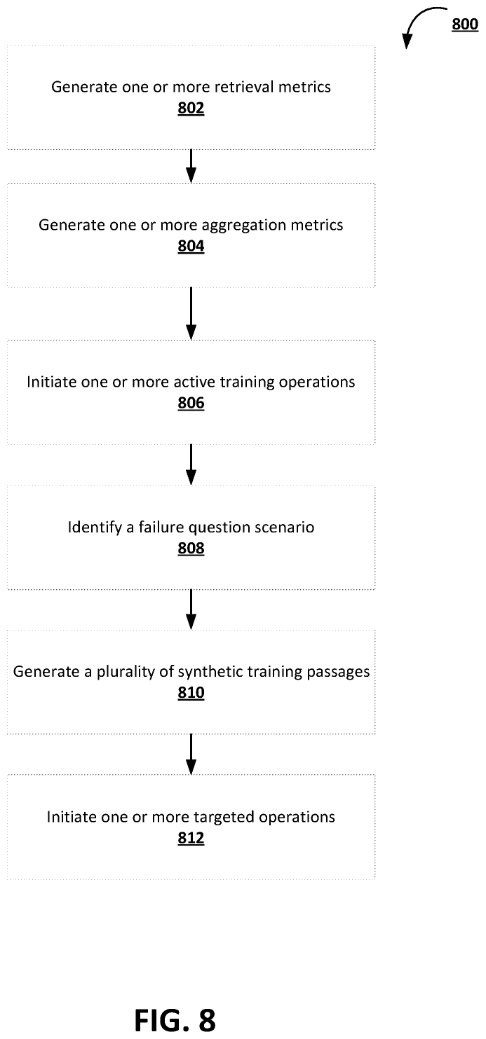

FIG. 8 is a flowchart diagram of an example process 800 for evaluating a question resolution process in accordance with some embodiments discussed herein. The flowchart depicts an evaluation and synthetic data generation process 800 for improving the accuracy of the question resolution process with respect to diverse use cases. The process 800 may be implemented by one or more computing devices, entities, and/or systems described herein. For example, via the various steps/operations of the process 800, the computing system 101 may leverage a retrieval metric and aggregation metric, and active learning to evaluate accuracy of question response. By doing so, the process 800 enables continuous learning and improves the accuracy of the question response.

In some embodiments, the process 800 includes at step/operation 802, generating one or more retrieval metrics for the question response. For example, the computing system 101 may generate one or more retrieval metrics for the question response based on the selected input passage. The computing system 101 may generate the one or more retrieval metrics using a retrieval scoring sub-module. In some embodiments, the one or more retrieval metrics comprise one or more of MRR score or MAP score.

In some embodiments, the process 800 includes at step/operation 804, generating one or more aggregation metrics. For example, the computing system 101 may generate the one or more aggregation metrics based on the question resolution. The computing system 101 may generate the one or more aggregation metrics using an aggregation scoring sub-module. In some embodiments, the one or more aggregation metrics include one or more of a BLEU score and/or a ROUGE score.

In some embodiments, the process 800 includes at step/operation 806, initiating one or more active training operations. For example, the computing system 101 may initiate one or more active training operations for the retrieval ensemble model and the machine learning aggregation model based on the retrieval metric and the aggregation metric.

In some embodiments, the process 800 includes at step/operation 808, identifying a failure question scenario. For example, the computing system 101 may identify the failure question scenario based on the input question, the retrieval metric, and/or the aggregation metric.

In some embodiments, the process includes at step/operation 810, generating a plurality of synthetic training passages. For example, the computing system 101 may generate a plurality of synthetic training passages from the set of input passages responsive to the failure question scenario and using a synthetic data generation model.

In some embodiments, the process includes at step/operation 812, initiating one or more targeted training operations. For example, the computing system 101 may initiate one or more based on the plurality of synthetic training passages.

FIG. 9 is an end-to-end block diagram showing example data structures and modules for the question response generation process in accordance with some embodiments discussed herein. In some embodiments, the machine learning pipeline includes a plurality of connected modules configured to perform one or more operation associated with a multi-stage machine-learning process. The multi-stage process, for example, may include a plurality of training and inference phases for training, implementing, and continuously retraining one or more machine learning models. The plurality of connected modules, for example, may include an annotation module 440, a dataset creation module 442, a fine-tuning module 444, an inference module 446, an evaluation module 448, and a synthetic data generation module 460.

The annotation module 440 may be configured to provide manual labels for training documents given a training question. For example, in a clinical domain, the annotation module may be configured for providing high-quality manual labels for medical documents given a clinical guideline. The annotation module 440 may include an annotation platform sub-module 440A and data quality assurance sub-module. The annotation platform sub-module 440A may be configured receive a training document set and output a set of training question response for training input questions along with the evidence passages from the document set. For example, in a clinical domain, the annotation module may be configured to receive a clinical guideline and a patient's medical documentation as input and output a set of answered questions from the guideline and the corresponding evidence for each question from the medical documentation. The data quality assurance sub-module may be configured to ensure the labels for the training documents satisfies quality thresholds by flagging mis-labeled outputs. The flagged mis-labeled output may be re-input into the annotation platform sub-module for relabeling or arbitration.

The dataset creation module 442 may be configured to generate a document set. The dataset creation module may include an OCR sub-module 442a, a document transformation sub-module 442b, and an annotation processing sub-module 442c. The OCR sub-module 442a may be configured to convert certain document types, such as PDF document type, to computer readable text. The OCR sub-module 442a may leverage one OCR techniques. In this manner, a dataset creation module may be configured to covert an image, such as scanned PDF document, into a format that is consumable by one or more models of the present disclosure.

The document transformation sub-module 442b may be configured to generate individual input questions from a plurality of input questions corresponding to a single criterion. For example, in a clinical domain, the document transformation sub-module may be configured to decompose a multiple-choice question into multiple separate input questions.

The annotation processing sub-module 442c may be configured to aggregate the annotated data output from different annotators. In some embodiments, the annotation processing sub-module 442c may determine and select the union of the annotation data (i.e., extracted evidence and the selected guideline choices) to form the annotated training set.

The finetuning module may include a retrieval sub-module 444a configured to train a retrieval ensemble model for performing one or more portions of a question resolution process and an aggregation sub-module 444b configured to train a machine learning aggregation model for performing one or more portions of a question resolution process.

The retrieval sub-module 444a may, during training phase and/or inference phase, leverage a temporal extraction model to perform temporal data retrieval operation(s), leverage a plurality of classification models to perform retrieval operations, and leverage a machine learning fusion model to perform fusion of the classification models. The temporal extraction model may be configured to generate temporal features from evidence passages using a finetuned LLM. The finetuned LLM may be previously finetuned using a set of temporal features output from one or more annotators or other LLM which may be powerful but expensive to run (e.g., LLAMA-70B).

In some embodiments, each classification model is finetuned to receive an input question and evidence passages as input and rank the evidence passages based on their relevance to the input question. In some embodiments, the finetuning task with respect to the one or more classification models is performed as a classification where a training evidence passage is assigned a positive label (e.g., “1”) when the input question and the training evidence passages are determined as being related, and a training evidence passage is assigned a negative label when the training input question and the evidence passages are determined as not being related. After finetuning the classification models, the weights of the classification models may be finetuned using a subset of the annotated training set (e.g., generated by the annotation module and the dataset creation module) to create an ensemble retrieval model. The ensemble retrieval model may outperform single-model baselines.

By way of example, the machine learning aggregation model may include one or more sub-classification models, one or more generative-pre-trained transformer model, one or more routing modules, and/or the like. In some embodiments, the one or more sub-classification models include one or more encoder-based LLMs 445 and/or one or more decoder-based LLMs 447. In some embodiments, the routing module may be configured to route an input question and set of input passages to an encoder-based LLM or decoder-based LLM based on the answer type associated with the input question.

In some embodiments, the aggregation sub-module 444b finetunes one or more encoder-based LLMs 445 to generate a question response for an input question associated with a multiple-choice answer type. A training input question and a set of training evidence passages (e.g., 5, 10, 20, etc. training evidence passages) from the annotated training set may be input to the encoder-based LLM to finetune the encoder-based LLM. The performance of the encoder-based LLM may depend on the manner in which the training evidence passages are selected. In this regard, in some embodiments, training evidence passages input to the encoder-based LLM are selected based on the output of the retrieval ensemble model (e.g., classification models thereof). In this manner, the machine learning aggregation model is exposed to evidence passages that are highly relevant to the input question but may not include the answer to the input question.

In some embodiments, the aggregation sub-module 444b finetunes one or more decoder-based LLMs 447 to generate a question response for an input question associated with a large-limited-set answer type (e.g., left knee, right knee, Yes/No, both knees). A training input question and a set of training evidence passages from the annotated training set may be input to the decoder-based LLM to finetune the decoder-based LLM.

In some embodiments, the generative-pre-trained transformer model 449 is configured to generate a question response for an input question associated with free-form answer type (e.g., how long the patient has been taking the medication?).

In some embodiments, the inference module 446 is configured to implement the trained retrieval ensemble model and/or machine learning aggregation model to perform one or more portions of the question resolution process. In some embodiments, the inference module is configured to receive a plurality of evidence passages from a document set corresponding to an input question. In some embodiments, the inference module is configured to generate, using the retrieval ensemble model (e.g., generated by the retrieval sub-module 444a), a plurality of evidence predictions for an evidence passage of the plurality of evidence passages based on the input question. In some embodiments, the inference module 446 is configured to generate, using the retrieval ensemble model, a weighted aggregate prediction for the evidence passage based on the plurality of evidence predictions. In some embodiments, the inference module is configured to select a set of input passages from the plurality of evidence passages based on the weighted aggregate prediction. In some embodiments, the inference module is configured to generate, using the machine learning aggregation model, a question response based on the set of input passages and the input question. In some embodiments, the inference module is configured to provide the question response. For example, the inference module may be configured to provide the question response to one or more computing devices.

In some embodiments, the evaluation module 448 is configured to evaluate the results of the machine learning pipeline/question resolution process after an inference round. For example, the evaluation module 448 may be configured to understand failed inferences (e.g., failed question scenarios) and to generate synthetic training passages for subsequent annotation or synthetic data generation rounds. In some embodiments, the evaluation module may include a retrieval scoring sub-module and an aggregation scoring sub-module. In some embodiments, the retrieval scoring sub-module may be configured to perform a portion of an evaluation operation associated with the evaluation module. For example, the retrieval scoring sub-module may be configured to generate one or more retrieval metrics to evaluate or otherwise assess the retrieval ensemble model, a portion thereof, or related processes. In some embodiments, the retrieval metric includes MRR score and/or MAP score, as described above.

In some embodiments, the synthetic data generation module 460 is configured to identify a failure question scenario based on the input question, the retrieval metric, and the aggregation metric. In some embodiments, the synthetic data generation module 460 is configured to generate, using a synthetic data generation model 490, a plurality of synthetic training passages from the set of input passages responsive to the failure question scenario. The synthetic data generation model 490 may, for example, comprise an LLM. In some embodiments, the synthetic data generation model 490 may comprise a pre-trained generative AI model configured to receive various natural language input (e.g., prompt) such as, for example, “You are tasked to rewrite a context such that the answer to the given question doesn't change.” The synthetic data generation may be advantageous, particularly, in cases where there is inadequate data (e.g., for rare diseases in a clinical domain).

In some embodiments, the synthetic training passages comprises a rephrasing of the input passages and/or similar input passages. In an example implementation the synthetic training passages may be added to an existing training data set (e.g., annotated training set) and/or replace one or more training passages in the existing training data set for subsequent training and/or inference rounds. For example, an input passage from the input question and input passage pair determined to generate an incorrect response may be excluded during subsequent evaluation.

In some embodiments, the synthetic data generation module is configured to initiate one or more targeted training operations based on the plurality of synthetic training passages.

### VI. Conclusion

Many modifications and other embodiments will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. Examples

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may include a single computing entity that is configured to perform all of the steps/operations of a particular example. In addition, or alternatively, a computing system may include multiple dedicated computing entities that are respectively configured to perform one or more of the steps/operations of a particular example. By way of example, the multiple dedicated computing entities may coordinate to perform all of the steps/operations of a particular example.

Example 1. A computer-implemented method comprising receiving, by one or more processors, a plurality of evidence passages from a document set corresponding to an input question; generating, by the one or more processors and using a retrieval ensemble model, a plurality of evidence predictions for an evidence passage of the plurality of evidence passages based on the input question; generating, by the one or more processors and using the retrieval ensemble model, a weighted aggregate prediction for the evidence passage based on the plurality of evidence predictions; selecting, by the one or more processors, a set of input passages from the plurality of evidence passages based on the weighted aggregate prediction; generating, by the one or more processors using a machine learning aggregation model, a question response based on the set of input passages and the input question; and providing, by the one or more processors, the question response.

Example 2. The computer-implemented method of example 1, wherein the retrieval ensemble model comprises a plurality of classification models and a machine learning fusion model.

Example 3. The computer-implemented method of example 2, wherein the plurality of classification models comprises a term-based retrieval model and one or more different large language models.

Example 4. The computer-implemented method of any of examples 2 or 3, wherein the machine learning fusion model is previously trained to generate the weighted aggregate prediction from the plurality of evidence predictions based on a correspondence between the plurality of classification models and the input question.

Example 5. The computer-implemented method of any of examples, 2-4, wherein the plurality of classification models and the machine learning fusion model are jointly trained using a subset of an annotated training set.

Example 6. The computer-implemented method of any of the above examples, further comprising generating a set of temporal features comprising a temporal data feature for each of the plurality of evidence predictions; and generating the question response based on the set of input passages, the input question, and the set of temporal features.

Example 7. The computer-implemented method of any of the above examples, wherein the plurality of evidence predictions for the evidence passage comprises a plurality of relevance rank values that each reflect a relevance of the evidence passage to the input question relative to the plurality of evidence passages.

Example 8. The computer-implemented method of any of the above examples, wherein the question response comprises a question resolution and a selected input passage from the set of input passages that corresponds to the question resolution.

Example 9. The computer-implemented method of example 8, further comprising generating, using a retrieval scoring sub-module, a retrieval metric for the question response based on the selected input passage; generating, using an aggregation scoring sub-module, an aggregation metric for the question response based on the question resolution; and initiating one or more active training operations for the retrieval ensemble model and the machine learning aggregation model based on the retrieval metric and the aggregation metric.

Example 10. The computer-implemented method of example 9, further comprising identifying a failure question scenario based on the input question, the retrieval metric, and the aggregation metric; responsive to the failure question scenario, generating, using a synthetic data generation model, a plurality of synthetic training passages from the set of input passages; and initiating one or more targeted training operations based on the plurality of synthetic training passages.

Example 11. The computer-implemented method of any of the above examples, wherein the machine learning aggregation model comprises a branched, multi-model architecture that defines (i) one or more sub-classification models comprising one of an encoder-based large language model, a decoder-based large language model, or a generative pre-trained transformer model and (ii) a routing module configured to route an input to one of the one or more sub-classification models.

Example 12. The computer-implemented method of any of the above examples, wherein generating the question response comprises routing, using the routing module, the input question and the set of input passages to a selected sub-classification model of one or more sub-classification models defined by the branched, multi-model architecture based on an answer type corresponding to the input question.

Example 13. A computing system comprising memory and one or more processors communicatively coupled to the memory, the one or more processors configured to receive a plurality of evidence passages from a document set corresponding to an input question; generate, using a retrieval ensemble model, a plurality of evidence predictions for an evidence passage of the plurality of evidence passages based on the input question; generate, using the retrieval ensemble model, a weighted aggregate prediction for the evidence passage based on the plurality of evidence predictions; select a set of input passages from the plurality of evidence passages based on the weighted aggregate prediction; generate, using a machine learning aggregation model, a question response based on the set of input passages and the input question; and provide the question response.

Example 14. The computing system of example 13, wherein the retrieval ensemble model comprises a plurality of classification models and a machine learning fusion model.

Example 15. The computing system of example 14, wherein the plurality of classification models comprises a term-based retrieval model and one or more different large language models.

Example 16. The computing system of any of examples 14 or 15, wherein the machine learning fusion model is previously trained to generate the weighted aggregate prediction from the plurality of evidence predictions based on a correspondence between the plurality of classification models and the input question.

Example 17. The computing system of any of examples 14-16 wherein the plurality of classification models and the machine learning fusion model are jointly trained using a subset of an annotated training set.

Example 18. The computing system of any of the above examples, wherein the one or more processors are further configured to generate a set of temporal features comprising a temporal data feature for each of the plurality of evidence predictions; and generate the question response based on the set of input passages, the input question, and the set of temporal features.

Example 19. The computing system of any of the above examples, wherein the plurality of evidence predictions for the evidence passage comprises a plurality of relevance rank values that each reflect a relevance of the evidence passage to the input question relative to the plurality of evidence passages.

Example 20. One or more non-transitory computer-readable storage media including instructions that, when executed by one or more processors, cause the one or more processors to receive a plurality of evidence passages from a document set corresponding to an input question; generate, using a retrieval ensemble model, a plurality of evidence predictions for an evidence passage of the plurality of evidence passages based on the input question; generate, using the retrieval ensemble model, a weighted aggregate prediction for the evidence passage based on the plurality of evidence predictions; select a set of input passages from the plurality of evidence passages based on the weighted aggregate prediction; generate, using a machine learning aggregation model, a question response based on the set of input passages and the input question; and provide the question response.

Example 21. The computer-implemented method of example 1, wherein the retrieval ensemble model comprises a plurality of machine learning classification models and the machine learning aggregation model comprises a large language model and the computer-implemented method further comprises receiving training data for the retrieval ensemble model and the machine learning aggregation model, wherein the training data comprises a plurality of training data objects each comprising (i) a training question, (ii) a training document set, (iii) one or more training passages from the training document set, and (iv) a training response; training, using one or more supervisory training techniques, the retrieval ensemble model based on the training question and the one or more training passages; and retraining, using one or more supervisory training techniques, the retrieval ensemble model and the machine learning aggregation model based on the training question and the training response.

Example 22. The computer-implemented method of example 21, wherein the training is performed by the one or more processors.

Example 23. The computer-implemented method of example 21, wherein the one or more processors are included in a first computing entity; and the training is performed by one or more other processors included in a second computing entity.

Example 24. The computing system of example 13, wherein the retrieval ensemble model comprises a plurality of machine learning classification models and a machine learning fusion model and the machine learning aggregation model comprises a large language model and the one or more processors are further configured to receive training data for the retrieval ensemble model and the machine learning aggregation model, wherein the training data comprises a plurality of training data objects each comprising (i) a training question, (ii) a training document set, (iii) one or more training passages from the training document set, and (iv) a training response; train, using one or more supervisory training techniques, the retrieval ensemble model based on the training question and the one or more training passages; and retrain, using one or more supervisory training techniques, the retrieval ensemble model and the machine learning aggregation model based on the training question and the training response.

Example 25. The computing system of example 13, wherein the one or more processors are included in a first computing entity; and the retrieval ensemble model and the machine learning aggregation model are trained by one or more other processors included in a second computing entity.

Example 26. The one or more non-transitory computer-readable storage media of example 20, wherein the retrieval ensemble model comprises a plurality of machine learning classification models and the machine learning aggregation model comprises a large language model and the one or more processors are further caused to receive training data for the retrieval ensemble model and the machine learning aggregation model, wherein the training data comprises a plurality of training data objects each comprising (i) a training question, (ii) a training document set, (iii) one or more training passages from the training document set, and (iv) a training response; train, using one or more supervisory training techniques, the retrieval ensemble model based on the training question and the one or more training passages; and retrain, using one or more supervisory training techniques, the retrieval ensemble model and the machine learning aggregation model based on the training question and the training response.

Example 27. The one or more non-transitory computer-readable storage media of example 20, wherein the one or more processors are included in a first computing entity; and the retrieval ensemble model and the machine learning aggregation model are trained by one or more other processors included in a second computing entity.

1. A computer-implemented method comprising:
receiving, by one or more processors, a plurality of evidence passages from a document set corresponding to an input question;
generating, by the one or more processors using a retrieval ensemble model and based at least in part on the input question, a plurality of evidence predictions for an evidence passage of the plurality of evidence passages;
generating, by the one or more processors and using the retrieval ensemble model, a weighted aggregate prediction for the evidence passage based on the plurality of evidence predictions;
determining, by the one or more processors and based at least in part on the weighted aggregate prediction, a set of input passages from the plurality of evidence passages;
routing, by the one or more processors, the set of input passages to a sub-classification model of a machine learning aggregation model to receive a question response for the input question; and
providing, by the one or more processors, the question response.

2. The computer-implemented method of claim 1, wherein the retrieval ensemble model comprises a plurality of classification models and a machine learning fusion model.

3. The computer-implemented method of claim 2, wherein the plurality of classification models comprises a term-based retrieval model and one or more different large language models.

4. The computer-implemented method of claim 2, wherein the machine learning fusion model is previously trained to generate the weighted aggregate prediction from the plurality of evidence predictions based on a correspondence between the plurality of classification models and the input question.

5. The computer-implemented method of claim 2, wherein the plurality of classification models and the machine learning fusion model are jointly trained using a subset of an annotated training set.

6. The computer-implemented method of claim 1, further comprising:
generating a set of temporal features comprising a temporal data feature for each of the plurality of evidence predictions; and
generating the question response based on the set of input passages, the input question, and the set of temporal features.

7. The computer-implemented method of claim 1, wherein the plurality of evidence predictions for the evidence passage comprises a plurality of relevance rank values that each reflect a relevance of the evidence passage to the input question relative to the plurality of evidence passages.

8. The computer-implemented method of claim 1, wherein the question response comprises a question resolution and a selected input passage from the set of input passages that corresponds to the question resolution.

9. The computer-implemented method of claim 8, further comprising:
generating, using a retrieval scoring sub-module, a retrieval metric for the question response based on the selected input passage;
generating, using an aggregation scoring sub-module, an aggregation metric for the question response based on the question resolution; and
initiating one or more active training operations for the retrieval ensemble model and the machine learning aggregation model based on the retrieval metric and the aggregation metric.

10. The computer-implemented method of claim 9, further comprising:
identifying a failure question scenario based on the input question, the retrieval metric, and the aggregation metric;
responsive to the failure question scenario, generating, using a synthetic data generation model, a plurality of synthetic training passages from the set of input passages; and
initiating one or more targeted training operations based on the plurality of synthetic training passages.

11. The computer-implemented method of claim 1, wherein the sub-classification model is one of one or more sub-classification models defined by the machine learning aggregation model and the machine learning aggregation model comprises a branched, multi-model architecture that defines (i) the one or more sub-classification models comprising one of an encoder-based large language model, a decoder-based large language model, or a generative pre-trained transformer model and (ii) a routing module configured to route an input to one of the one or more sub-classification models.

12. The computer-implemented method of claim 11, wherein generating the question response comprises:
routing, using the routing module, the input question and the set of input passages to the sub-classification model of the one or more sub-classification models based on the answer type corresponding to the input question.

13. A system comprising:
one or more processors; and one or more memories storing processor-executable instructions that, when executed by the one or more processors, cause the one or more processors to perform operations comprising:
receiving a plurality of evidence passages from a document set corresponding to an input question;
generating, using a retrieval ensemble model and based at least in part on the input question, a plurality of evidence predictions for an evidence passage of the plurality of evidence passages;
generating, using the retrieval ensemble model, a weighted aggregate prediction for the evidence passage based on the plurality of evidence predictions;
determining, and based at least in part on the weighted aggregate prediction, a set of input passages from the plurality of evidence passages;
routing the set of input passages to a sub-classification model of a machine learning aggregation model to receive a question response for the input question; and
providing the question response.

14. The system of claim 13, wherein the retrieval ensemble model comprises a plurality of classification models and a machine learning fusion model.

15. The system of claim 14, wherein the plurality of classification models comprises a term-based retrieval model and one or more different large language models.

16. The system of claim 14, wherein the machine learning fusion model is previously trained to generate the weighted aggregate prediction from the plurality of evidence predictions based on a correspondence between the plurality of classification models and the input question.

17. The system of claim 14, wherein the plurality of classification models and the machine learning fusion model are jointly trained using a subset of an annotated training set.

18. The system of claim 13, wherein the one or more processors are further configured to:
generate a set of temporal features comprising a temporal data feature for each of the plurality of evidence predictions; and
generate the question response based on the set of input passages, the input question, and the set of temporal features.

19. The system of claim 13, wherein the plurality of evidence predictions for the evidence passage comprises a plurality of relevance rank values that each reflect a relevance of the evidence passage to the input question relative to the plurality of evidence passages.

20. One or more non-transitory computer-readable storage media including instructions that, when executed by one or more processors, cause the one or more processors to perform operation comprising:
receiving a plurality of evidence passages from a document set corresponding to an input question;
generating, using a retrieval ensemble model and based at least in part on the input question, a plurality of evidence predictions for an evidence passage of the plurality of evidence passages;
generating, using the retrieval ensemble model, a weighted aggregate prediction for the evidence passage based on the plurality of evidence predictions;
determining, based at least in part on the weighted aggregate prediction, a set of input passages from the plurality of evidence passages;
routing the set of input passages to a sub-classification model of a machine learning aggregation model to receive a question response for the input question; and
providing the question response.
